(19) United States
(12) Patent Application Publication
(10) Pub. No.: US 2022/0402150 A1
(43) Pub. Date: Dec. 22, 2022

(54) ARTICULATING BLADE ASSEMBLY FOR HAIR REMOVAL DEVICE

(71) Applicant: Church & Dwight Co., Inc., Princeton, NJ (US)

(72) Inventor: Eric Langberg, Milford, PA (US)

(73) Assignee: Church & Dwight Co., Inc., Princeton, NJ (US)

(21) Appl. No.: 17/777,240

(22) PCT Filed: Nov. 18, 2020
(86) PCT No.: PCT/IB2020/060876

§ 371 Date: May 16, 2022

Related U.S. Application Data
(60) Provisional application No. 62/936,999, filed on Nov. 18, 2019.

(51) Int. Cl. B26B 19/04; B26B 19/38

(52) U.S. Cl. CPC B26B 19/048; B26B 19/386; B26B 19/3846

(57) ABSTRACT

The present disclosure provides an articulating blade assembly that can include a blade housing, a mount arranged to rotationally engage the blade housing, a biasing element configured to bias the blade housing to a neutral position while allowing for rotation, and a handle adapter. The articulating blade assembly is configurable with a body of a hair removal device. As such, the disclosure further provides a hair removal device incorporating the articulating blade assembly and also a method for manufacturing an articulating blade assembly.

### FIELD OF THE DISCLOSURE

The present disclosure relates to a blade assembly. More particularly, the present disclosure relates to an articulating blade assembly for a hair removal device.

### BACKGROUND

Typically, blade assemblies of hair removal devices move in two opposing directions from a neutral position such that the blade assembly will pivot during use to ensure substantially constant contact of the blade assembly with the skin surface during movement along the surface. Many such assemblies utilize a solid axle that extends continuously from one side of the assembly to the opposing side to form the axis of rotation. A coil spring is typically positioned so as to surround the solid axle and provide the restoring force. Alternatively, an axle can be formed by one or more pins with a coil spring positioned around one or more pins. Such options for pivoting a blade assembly can be lacking in that the biasing elements need to be pre-tensioned in order to be functional to generate the required biasing force, and such requirement can make assembly of the devices quite difficult. This particularly the case when an end user may be required to re-assemble a blade assembly that has been dislodged due to dropping or the like.

Known blades assemblies likewise can suffer from a tendency of the axle or pins to break or to cause damage to other parts of the device during a drop test. Even if the assembly is not broken due to dropping, the springs may readily be dislodged from the assembly and can be difficult, if not practically impossible, for the average consumer to put back together.

As seen from the foregoing, known blade assemblies can suffer from insecure or unstable attachment, from a tendency to break upon dropping, and/or from difficulty in reattaching blade assemblies that may become dislodged from the device, such as from dropping. Accordingly, there exists a need for an articulating blade assembly for a hair removal device that addresses or solves at least the above-mentioned matters.

### BRIEF SUMMARY OF THE DISCLOSURE

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

In one or more embodiments, the present disclosure can provide blade assemblies that are combinable with a handle to form a hair removal device. The blade assembly can be pivotable in a plurality of direction and, as such, can be characterized as an articulating blade assembly for a hair removal device. In some embodiments, such articulating blade assembly can comprise: a blade housing comprising a blade retained therein; a mount arranged to rotationally engage the blade housing so as to define an axis of rotation; a biasing element having a first portion biased against the blade housing and a second portion biased against the mount such that pivoting of the blade housing about the axis of rotation causes the first portion biased against the blade housing to exert an opposing force upon the blade housing; and a handle adapter engaged with the mount and aligned with a centrally-defined opening in the mount so as to engage a device body of the hair removal device. In further embodiments, the articulating blade assembly can be defined in relation to one or more of the following statements, which can be combined in any number and order to define a variety of configuration that are immediately recognizable in light of the further disclosure provided herein.

The biasing element can be formed integral with or attachable to the mount.

The mount can be formed of a plastic, a metal, a wood, or a combination thereof.

The biasing element can comprise a magnet, and wherein pivoting of the blade housing about the axis of rotation causes increases and decreases in magnetic field strength thereby creating opposing magnetic forces which bias the blade housing toward an initial position.

The blade housing can be pivotable about the axis of rotation in either of two opposing directions from an initial position.

The blade housing can extend longitudinally from a first end to an opposing second end and comprises a front surface and an opposing rear surface, the rear surface extending upward from each of the first end and the opposing second end to form drums having outer faces extending away from one another and force-receiving structures extending upward and parallel to one another.

The force-receiving structures each can comprise a force-receiving surface, the force-receiving surfaces being substantially co-planar with one another.

The mount can extend longitudinally from a first end to an opposing second end, each of the first end and the opposing second end defining a drum recess such that the drums of the first end and the opposing second end of the blade housing are arranged to engage respective drum recesses of the first end and the opposing second end of the mount and define the axis of rotation.

The first end and the opposing second end of the mount each further can comprise a pin having an outer face, the outer faces of the pins extending toward one another.

The biasing element can be a torsion spring having a coiled central portion arranged between the first portion and the second portion and arranged about a respective one of the pins, and wherein the first portion defines a moving end biased against the blade housing and the second portion defines a constrained end biased against the mount, such that pivoting of the blade housing about the axis of rotation causes the first portion to exert the opposing force against the blade housing.

The constrained end can be biased against a top surface of the mount and the moving end is biased against the respective force-receiving structure of the blade housing, such that pivoting of the blade housing about the axis of rotation causes the moving ends of the torsion springs to exert an opposing force upon the respective force-receiving structures.

The articulating blade assembly further can comprise two torsion springs and two pins, each of the torsion springs having the coiled central portion arranged about the respective one of the two pins.

In some embodiments, the present disclosure further can provide hair removal devices. Such devices can include a blade assembly and a device body that is engagable with the blade assembly to form a functioning hair removal device. In example embodiments, a hair removal device according to the present disclosure can comprise: a blade assembly that includes: a blade housing comprising a blade retained therein and extending longitudinally from a first end to an opposing second end and comprising a front surface and an opposing rear surface, the rear surface extending upward from each of the first end and the opposing second end to form drums having outer faces extending away from one another and force-receiving structures extending parallel to one another; a mount extending longitudinally from a first end to an opposing second end, each of the first end and the opposing second end defining a drum recess such that the drums of the first end and the opposing second end of the blade housing are arranged to engage respective drum recesses of the first end and the opposing second end of the mount and define an axis of rotation, and the first end and the opposing second end of the mount each further comprising a pin having an outer face, the outer faces of the pins extending toward one another; and a torsion spring having a coiled central portion arranged between a constrained end and a moving end of the torsion spring and arranged about a respective one of the pins, where the constrained end is biased against a top surface of the mount and the moving end is biased against the respective force-receiving structure of the blade housing, such that pivoting of the blade housing about the axis of rotation causes the moving ends of the torsion springs to exert an opposing force upon the respective force-receiving structures; and a device body arranged to engage the blade assembly. In further embodiments, the hair removal device can be defined in relation to one or more of the following statements, which can be combined in any number and order to define a variety of configuration that are immediately recognizable in light of the further disclosure provided herein

The hair removal device further can comprise a handle adapter engaged with the mount and aligned with a centrally-defined opening in the mount so as to engage the device body of the hair removal device.

The torsion spring can be formed integral with or attachable to the mount.

The blade housing can be pivotable about the axis of rotation in either of two opposing directions from an initial position relative to the device body.

The force-receiving structures each can comprise a force-receiving surface, the force-receiving surfaces of each of the force-receiving structures being substantially co-planar with one another.

The hair removal device further can comprise two torsion springs and two pins, each of the torsion springs having the coiled central portion arranged about the respective one of the two pins.

In further embodiments, the present disclosure can provide methods for manufacturing an articulating blade assembly. For example, a method for manufacturing an articulating blade assembly can comprise: providing a blade housing comprising a blade retained therein and extending longitudinally from a first end to an opposing second end and comprising a front surface and an opposing rear surface, the rear surface extending upward from each of the first end and the opposing second end to form drums having outer faces extending away from one another and force-receiving structures extending upward from each of the first end and the opposing second end and parallel to one another; engaging a mount extending longitudinally from a first end to an opposing second end with the blade housing by engaging a drum recess defined in each of the first end and the opposing second end of the mount with the respective drums of the first end and the opposing second end of the blade housing so as to define an axis of rotation, the first end and the opposing second end of the mount each further comprising a pin having an outer face, the outer faces of the pins extending toward one another; arranging a coiled central portion of a torsion spring about a respective one of the pins, the coiled central portion being arranged between a constrained end and a moving end of the torsion spring; and biasing the constrained end of the torsion spring against a top surface of the mount and the moving end of the torsion spring against the respective force-receiving structure of the blade housing, such that pivoting of the blade housing about the axis of rotation causes the moving ends of the torsion springs to exert an opposing force upon the respective force-receiving structures. In further embodiments, the methods may incorporate one more additional steps and thus may be defined in relation to further elements. For example, in some embodiments, such methods further can comprise engaging a device body with the articulating blade assembly to form a hair removal device.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 is a cross-sectional view of a hair removal apparatus for use with an articulating blade assembly according to embodiments of the present disclosure;

FIG. 2 is a plan view of a hair removal apparatus for use with an articulating blade assembly according to embodiments of the present disclosure;

FIG. 3 is another plan view of a hair removal apparatus for use with an articulating blade assembly according to embodiments of the present disclosure;

FIG. 4 is a partially exploded view of a hair removal apparatus for use with an articulating blade assembly according to embodiments of the present disclosure;

FIG. 5 is a partially assembled view of a hair removal apparatus for use with an articulating blade assembly according to embodiments of the present disclosure;

FIG. 6 is another view of the partially assembled hair removal apparatus of FIG. 5 for use with an articulating blade assembly according to embodiments of the present disclosure;

FIG. 7 is a perspective view showing connectivity between a blade assembly and a hair removal apparatus;

FIG. 8 is a perspective view of a blade assembly;

FIG. 9A is a partial perspective view of a power cord for use with a hair removal apparatus as described herein;

FIG. 9B to FIG. 9K show partial perspective views of a hair removal apparatus in various states illustrating further components of a rearward portion thereof;

FIG. 10A to FIG. 11D show partial perspective views of a hair removal apparatus in various states illustrating further components of a forward portion thereof;

FIG. 11E is a partial cross-sectional view of a hair removal apparatus illustrating further internal components thereof;

FIG. 12 is a partial perspective view of a hair removal apparatus illustrating further components thereof;

FIG. 13A to FIG. 14E show various views of a blade assembly for connection to a hair removal apparatus;

FIG. 15A to FIG. 15D show various views of a blade assembly and hair removal apparatus illustrating connectivity therebetween;

FIG. 16 shows a perspective view of an articulating blade assembly according to embodiments of the present disclosure;

FIG. 17 shows a further perspective view of an articulating blade assembly according to embodiments of the present disclosure;

FIG. 18 shows a partially exploded view of an articulating blade assembly according to embodiments of the present disclosure;

FIG. 19 shows a perspective view of a mount component of an articulating blade assembly according to embodiments of the present disclosure;

FIG. 20 shows a partially exploded view of an articulating blade assembly according to embodiments of the present disclosure;

FIG. 21 shows another partially exploded view of an articulating blade assembly according to embodiments of the present disclosure; and

FIG. 22A to FIG. 22I provides partial cross-sectional illustrations of various biasing element shapes and arrangements of an articulating blade assembly for a hair removal according to example embodiments of the present disclosure.

### DETAILED DESCRIPTION OF THE INVENTION

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural variations unless the context clearly dictates otherwise.

In one or more embodiments, the present disclosure relates to an articulating blade assembly configured or adapted to provide for secure and reliable attachment of the blade assembly to a handle and movement of the blade assembly during use. More particularly, the articulating blade assembly provides at least the benefits of consistent feel, dual rocking motion, self-positioning, and ease of assembly and reassembly after separation from a handle.

The articulating blade assembly can include at least the blade assembly itself and one or more frame members that are configured or adapted to connect the blade assembly to a handle apparatus, which itself can include a variety of components suitable for driving the blade assembly in a hair-cutting arrangement. The blade assembly in combination with a suitable can be referenced as a hair removal apparatus or assembly, and such hair-cutting assembly or apparatus can relate to any type of hair removal apparatus having at least one blade, such as, but not limited to, a razor, a dermaplaning device, a trimmer, and the like.

In an example embodiment, a suitable handle apparatus can comprise a shell (which may be defined by one or a plurality of layers) and which may comprise a generally linear internal cavity, and front and rear ends, each end having an opening. The apparatus may comprise a core frame structure comprising front, middle and rear sections, where the core frame structure has a corresponding generally linear shape designed to fit within the generally linear internal cavity of the shell by inserting the core frame structure into the open rear end of the shell and allowing a portion of the front section to protrude from the open front end of the shell. An articulating blade assembly as particularly described herein can be removably attachable to the handle and can include, for example, a blade housing, a moving blade, and a stationary blade. When the handle and the articulating blade assembly are interconnected, the portion of the front section of the core frame structure can engage and move the moving blade.

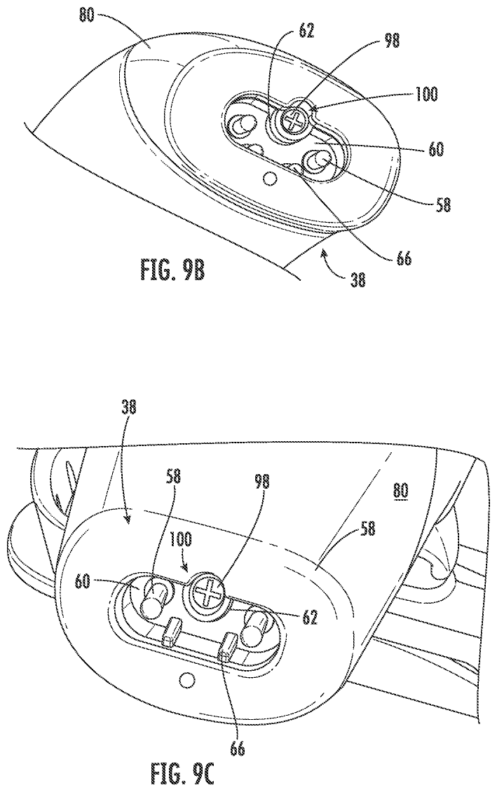

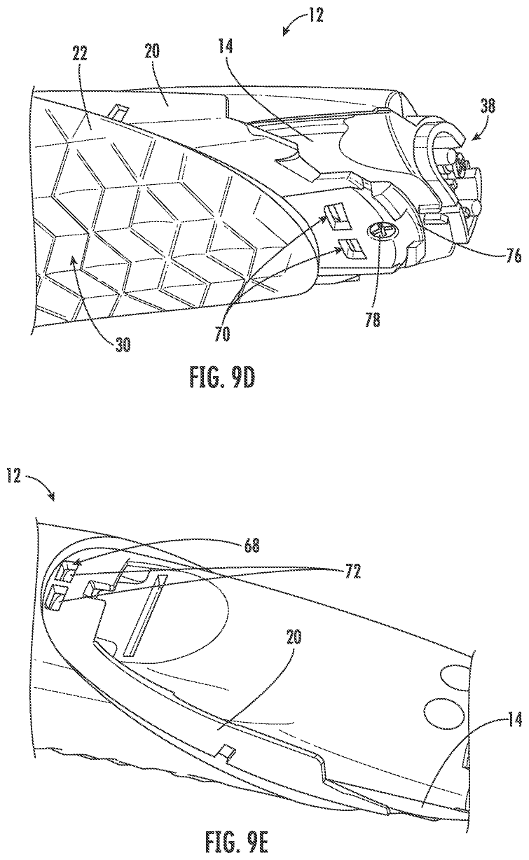

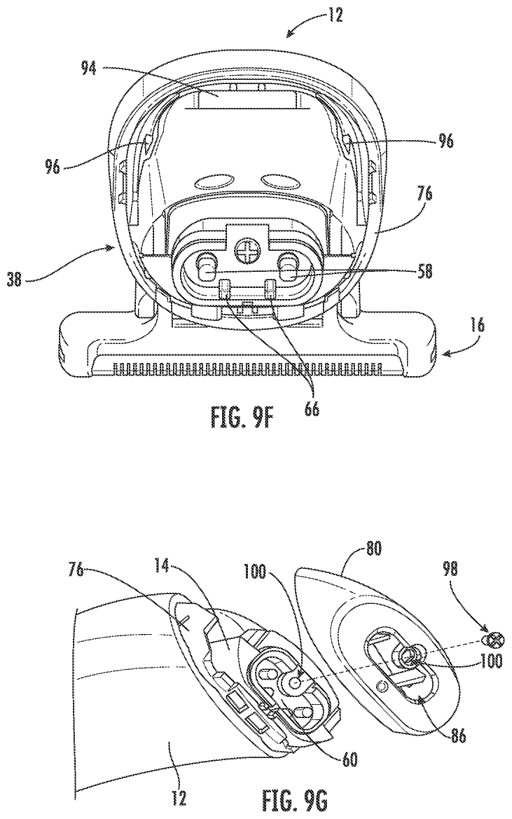

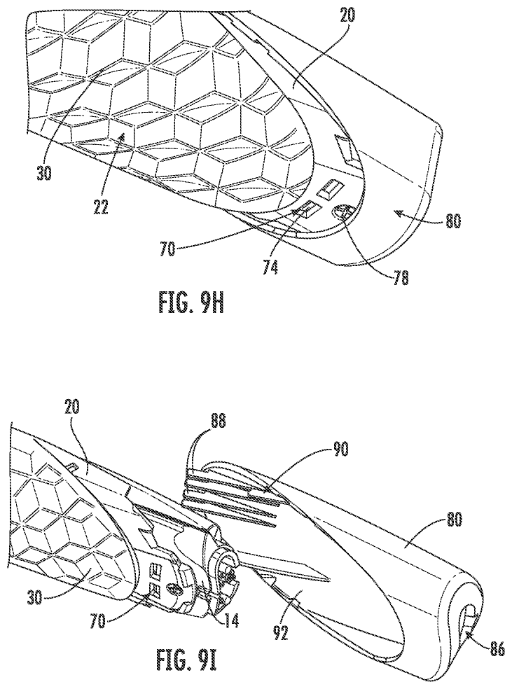

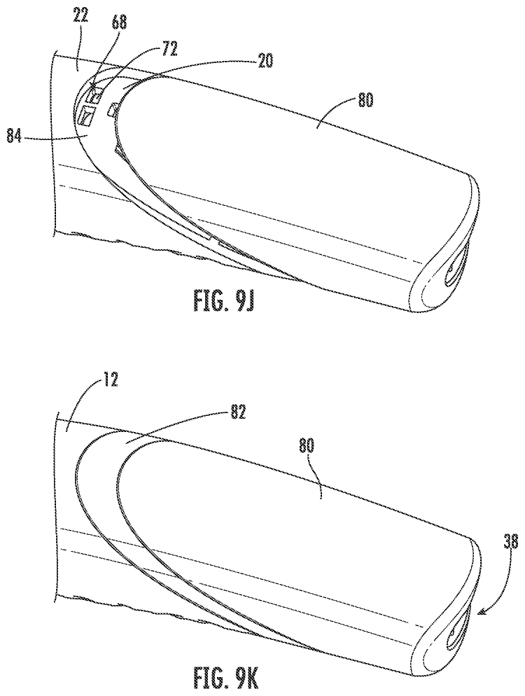

FIGS. 1-8 of the present application illustrate an example embodiment of a hair removal apparatus and provide a basis for understanding how the articulating blade assembly provided according to the present disclosure can be removably attached to a handle portion to provide a working hair removal apparatus. As illustrated, a hair removal apparatus 10 can comprise three main elements: a shell 12, a core frame structure 14, and a blade assembly 16. The shell 12 and the core frame structure 14 interact and form a handle 18 for a user to grip during use. Detailed views of the elements of each of the shell 12, the core frame structure 14, and the blade assembly 16 are provided in FIGS. 9A-15D and are described below.

Referring first to the shell 12 as shown in FIG. 1, one or more layers may be attached or coupled to one another to form the shell 12. For example, the shell 12 may have a first layer 20 and a second layer 22. More layers are also contemplated, such as a third layer, fourth layer, fifth layer, etc. The first layer 20 may be considered a rigid layer that is inflexible and resistant to being bent or forced out of shaped so as to provide support to the hair removal apparatus 10. The first layer 20 may be formed of a polymeric material such as plastic, which may be formed from a renewable material such as corn or cellulose. The first layer 20 may be formed by three-dimensional (3D) printing, machining, casting, molding, vacuum forming, or any similar type of manufacturing method that yields the desired shape of the first layer 20. In some example embodiments, the first layer 20 along with the second layer 22 (and thereby the shell 12 and the handle 18) may be curved or have an arc-shape along a length of the shell 12, the length of the shell 12 being defined by a longitudinal axis A extending along the X-axis, from an open rear end 24 to an open front end 26. For example, the curvature of the first layer 20 may be formed from the open front end 26 and the open rear end 24 being curved downward in a Y-direction, away from the X-axis, so that an apex of the curve is around a middle of the shell 12, so that the curvature forming a grip extends between the open front and rear ends 24, 26. The curvature of the first layer 20 may also be formed from the open rear end 24 being wider in a Z-direction. As such, the curvature of the first layer 20 and the second layer 22 may result in the shell 12 and the handle 18 being considered “curved” along the X-axis in the Y-direction and/or the Z-direction.

In some example embodiments, the first layer 20 is formed with a hollow interior that defines an internal cavity 28. The internal cavity 28 may extend along the length of the shell 12 from the open rear end 24 to the open front end 26 of the shell 12. In order to create a seal in the internal cavity 28, gaskets or another type of sealing mechanism may be provided at the open rear end 24 and the open front end 26. The internal cavity 28 may be considered generally linear, as a majority of the length of the internal cavity 28 is linear and not curved. For example, and as illustrated in FIG. 1, at least a middle portion 28a of the internal cavity 28 is linear along the X-axis and comprises parallel upper and lower surfaces, while a front portion 28b and a rear portion 28c are slightly curved downward in a Y-direction away from the X-axis.

The second layer 22 may be considered a resilient layer that is flexible and able to spring back into shape after being bent, stretched, and/or compressed. The second layer 22 may also be formed of a polymeric material such as plastic. However, the second layer 22 may be more flexible than the first layer 20 and therefore, more comfortable to a user when grasping the hair removal apparatus 10. The second layer 22 may be formed by 3D printing, molding, bonding, adhesives, binding agents, and combinations thereof, the second layer 22 onto the first layer 20. In this manner, the shape of the first layer 20 may determine the shape of the second layer 22.

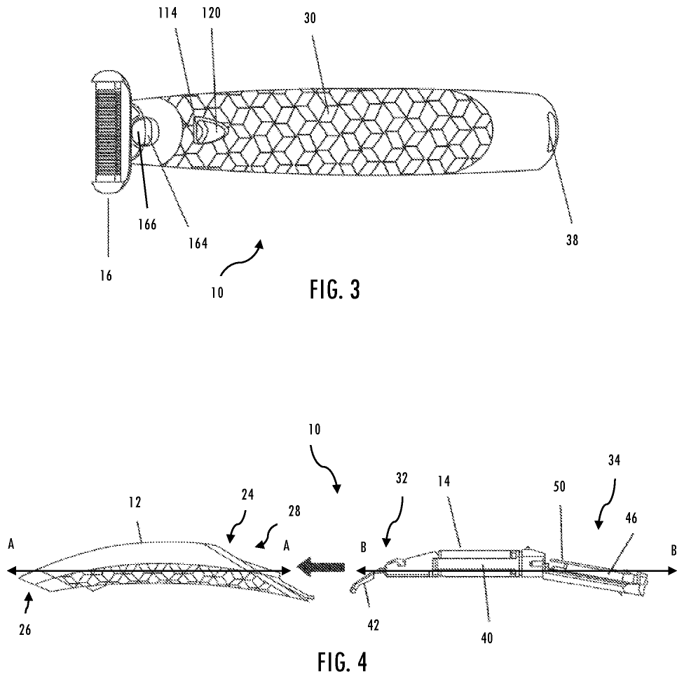

In some example embodiments, where the second layer 22 is the last layer used to form the shell 12, the second layer 22 may be considered as an outer surface of the shell. Thus, where the first layer 20 is curved as described herein, then with the attachment of the second layer 22 to the first layer 20, a curved handle 18 may be formed with a curved shell 12 having a curved outer surface. Further, where the second layer 22 is considered the outer surface of the shell 12, the handle 18 may have a curvature forming a grip for a user to grasp during use. In addition, the handle 18 may define a gripping surface 30 (FIG. 3) on a portion of the second layer 22. As illustrated in FIG. 3, for example, the gripping surface 30 may be formed as a textured portion of the second layer 22, or may otherwise be formed on or with the second layer 22 to provide a non-slip surface for a user to ergonomically grasp.

Accordingly, as described herein, the first layer 20 may be considered as being formed as a one-piece construction, where the first layer 20 is manufactured such that there is not more than one element forming the first layer 20 or, if more than one element forms the first layer 20, the elements are so engaged with one another (e.g., via ultrasonic welding) that the first layer 20 can be considered unitary or integral. More particularly, as is known in the art, it is often more cost-efficient to manufacture hair removal apparatuses with a structure having a top half and a bottom half (relative to the Y-direction) that attach to one another. When there is a top half and a bottom half a seam is formed at the attachment, which may be susceptible to infiltration of water and debris into the internal cavity 28. However, in order to enable a more substantially water resistant or waterproof hair removal apparatus, the present disclosure contemplates forming the first layer 20 so that there is not more than one element (or if more than one element forms the first layer 20, the elements are so engaged with one another they are considered unitary or integral) forming the first layer 20. When the second layer 22 is attached to the first layer 20 formed as a one-piece construction, as described herein, a curved outer shell 12 with a substantially continuous outer surface is formed from the second layer 22 creating a substantially waterproof tight seal with the first layer 20 so as to protect the core frame structure 14 and components within. More particularly, to be considered a “substantially continuous outer surface,” the second layer 22 covers a substantial entirety of the first layer 20 having a one-piece construction so that a substantial entirety of the second layer 22 (i.e., the outer surface) has no seams or is “seamless.” Without seams, the outer surface appears visually sleek and aesthetically appealing, and also prevents accumulation of debris in any seams and leakage of water into the internal cavity 28. As a result, the core frame structure 14 is insertable through the open rear end 24 and not sandwiched between two separate components of the first layer 20 as is typical in the art. However, a first layer 20 having a two-piece construction, three-piece construction, four-piece construction, etc., is contemplated by the disclosure herein, as well.

Referring now to the core frame structure 14, the core frame structure 14 may define a first end 32 and an opposing second end 34 with one or more mechanically and/or electrically interconnected elements that are securely positioned relative to one another. When the core frame structure 14 is inserted into the shell 12, in some example embodiments, the second layer 22 of the shell 12 may contact the core frame structure 12 and creates a seal.

In some example embodiments, the elements of the core frame structure 14 comprise a transmission 36 arranged toward the first end 32 of the core frame structure 14, a charging receptacle 38 arranged toward the second end 34 of the core frame structure 14, and a motor 40 arranged between the transmission 36 and the charging receptacle 38 and being coupled to the transmission 36. For example, the motor 40 is mechanically-connected to the transmission 36. The motor 40 may be a DC motor, such as, for example, a brushed DC motor, a brushless DC motor, a stepper motor, and the like. Alternatively, the motor 40 may be a brushless AC motor or a linear motor.

A transmission arm 42, which may comprise a separate or integral mechanical coupling 44 for mechanically coupling the transmission arm 42 with the transmission 36. The mechanical coupling 44 may be an end portion of the transmission arm 42 having parallel side walls that alternatingly come into contact with an offset pin of the rotating transmission 36 when the transmission 36 is actuated. Rotary motion of the motor 40 may be transmitted to the transmission 36, which may thereby be converted to reciprocating motion via the mechanical coupling 44. This conversion from the rotary motion of the motor 40 to lateral reciprocation of the transmission arm 42 is completed within the handle 18 as a result of the structure of the mechanical coupling 44. The lateral reciprocation of the mechanical coupling 44 thereby causes the transmission arm 42 to laterally reciprocate in response to actuation of the motor 40.

A power source 46 may be arranged between the motor 40 and the charging receptacle 38. The power source 46 may be a rechargeable battery securely positioned in a power source compartment 48 formed by the core frame structure 14 and arranged toward the second end 34 of the core frame structure 14. The power source 46 may be a power storage component that is electrically-connected to the motor 40 directly or via a first circuit board 50 that may also be housed in or adjacent to the power source compartment 48. The power source 46 may be electrically connected to the charging receptacle 38 directly or via the first circuit board 50.

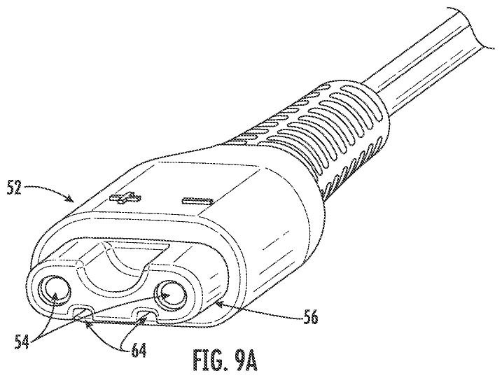

Referring now to FIGS. 9A-9K, the charging receptacle 38 may comprise a charging port arranged toward the second end 34 of the core frame structure 14 that is formed to receive a charging unit 52 (FIG. 9A) with a mating male or female plug. As shown in FIG. 9A, female electrical contacts 54 formed on an outwardly extending portion 56 of the charging unit 52 may align with male charging pins 58 (FIGS. 9B and 9C) extending from a planar surface 60 on the charging receptacle 38, where the planar surface 60 forms the second end 34 of the core frame structure 14. The planar surface 60 may include an arc 62, so that the planar surface 60 is not fully oval-shaped. The male charging pins 58 may form an industry standard connector (e.g., a USB connector, a coaxial barrel connector, a lightning connector, etc.), or may be custom-formed in a specific arrangement. Otherwise, the charging port may be arranged to receive a USB-A, USB-B, mini-USB, micro-USB, USB 3, a FIG. 8 connector, etc., or may be integral with the charging unit 52. Alignment of the charging receptacle 38 and the charging unit 52 may be accomplished through alignment of notches 64 defined in the outwardly extending portion 56 of the charging unit and ribs 66 extending from the planar surface 60. Notably, the alignment of the notches 64 and the ribs 66, along with the arc 62, form a keying system such that the charging unit 52 may only be inserted into the charging receptacle 38 in a single orientation. Further, the keying system prevents the female electrical contacts 54 of the charging unit 52 from making physical contact with the male charging pins 58 of the charging receptacle 38 if insertion of the charging unit 52 is attempted while the charging unit 52 is accidentally reversed. However, the charging unit 52 and the charging receptacle 38 may be constructed so that the charging unit 52 may be able to be inserted into the charging receptacle 38 in any orientation.

Alternatively, the charging receptacle 38 may comprise charging contacts. The charging contacts may be a metallic material and may be plated so as to appear gold or rose-gold in color, although other colors are also contemplated. The charging contacts may be arranged toward the second end 34 of the core frame structure 14, so that when the charging receptacle 38 is brought into contact with the charging unit 52, corresponding charging contacts of the charging unit 52 are aligned and in electrical communication with the corresponding charging contacts of the charging receptacle 38.

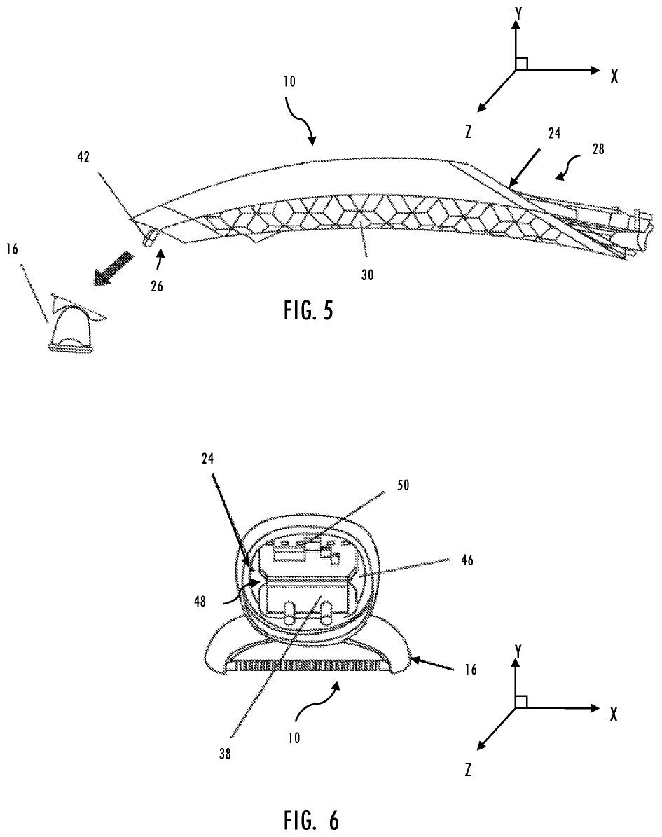

Referring back to FIG. 4, in some example embodiments the shell 12 is configured to receive the core frame structure 14 through the open rear end 24 of the shell 12 so that the core frame structure 14 is positioned in the internal cavity 28 of the shell 12 such that the transmission 36 is arranged near the open front end 26 of the shell 12. In particular, the first end 32 of the core frame structure 14 may be inserted through the open rear end 24 of the shell 12 and into the internal cavity 28 of the shell 12. With this insertion, the transmission arm 42 may extend through the open front end 26 of the shell 12 for coupling with the blade assembly 16, as illustrated in FIG. 5. Such insertion is done in a substantially linear motion manually or by machine, and is enabled due to the shape of the internal cavity 28 and the shape of the core frame structure 14. Generally, the core frame structure 14 has a shape that corresponds to a shape of the internal cavity 28 for ease of insertion during manufacture. For example, where the internal cavity 28 has a generally-linear shape (i.e., at least the middle portion 28a of the internal cavity 28 is linear along the X-axis, while the front portion 28b and the rear portion 28c are curved), the core frame structure 14 has a corresponding generally-linear shape, with at least a middle portion 14a of core frame structure 14 (including the motor 40 and transmission 36 forming a substantially sealed cavity with the shell) being linear along the X-axis, while a front portion 14b (including the transmission arm 42 forming a substantially sealed cavity) and a rear portion 14c (including the power source compartment 48 forming a sealed cavity around the power source 46 and the first circuit board 50) are curved downward in a Y-direction away from the X-axis. Thus, the open rear end 26 of the shell 12 may be angled away from or downward relative to the longitudinal axis A of the shell 12 extending along the length thereof, and the second end 34 of the core frame structure 14 may be correspondingly angled away from or downward relative to a longitudinal axis B of the core frame structure 14, which is co-axial with the longitudinal axis A, extending along a length of the core frame structure 14 defined along the X-axis.

The shell 12 and the core frame structure 14 may be secured to one another in any number of ways once the core frame structure 14 is inserted into the shell 12. For example, and as illustrated in FIGS. 9D and 9E, top and bottom locking notches 68, 70 defined in the first layer 20 may align with corresponding top and bottom catches 72, 74 arranged on a ramp 76 of the core frame structure 14, once the core frame structure 14 has been successfully inserted into the shell 12. The notches 68, 70 and the bottom catches 72, 74 on the ramp 76 may secure the core frame structure 14 to inside the shell 12. Further, a frame screw 78 may be inserted through the first layer 20 and into the core frame structure 14 through an opening in the first layer 20. Other methods of securing the core frame structure 14 to the shell 12 are also contemplated by this disclosure, and may include the addition of bonding or an adhesive applied to the core frame structure 14 so that it may adhere to the internal cavity 28 upon insertion of the core frame structure 14 into the shell 12.

Once the core frame structure 14 is inserted within the shell 12, and as illustrated in FIGS. 9F-9K, a rear cover 80 may be engageable with the open rear end 24 of the shell 12 so as to cover and form a seal over the open rear end 24 of the shell 12. The open rear end 24 of the shell 12 may be angled in such a way that a top of the open rear end 24 is farther away from a rear edge of the hair removal apparatus 10 than a bottom of the opening of the open rear end 24. The rear cover 80 may be formed so as to complement the open rear end 24 of the shell 12, e.g., have a corresponding angle. The rear cover 80 and a trim ring 82 may be received on an interior rim 84 formed on the first layer 20. The trim ring 82 may be a metallic-colored material (e.g., rose gold) so that it appears metallic in appearance. The trim ring 82 may be assembled on the interior rim 84 prior to the rear cover 80 being assembled over the open rear end 24 of the shell 12. While the rear cover 80 may be removable or fixed, the trim ring 82 may be secured in place using glue, ultrasonic welding, or by pressure applied to the rear cover 80. With the rear cover 80 and the trim ring 82 assembled and contacting the interior rim 84 and the second layer 22, a seal is created to prevent water and debris from entering internal cavity 28. The seal can also be formed by using a gasket or any other similar method of sealing the internal cavity 28 to make it waterproof.

To secure the rear cover 80 to the shell 12, the rear cover 80 may define an aperture 86. At least a portion of the charging receptacle 38 may extend out of the shell 12 and into the aperture 86 of the rear cover 80 when the rear cover 80 is engaged with the open rear end 24 of the shell 12. Upper ribs 88 and side ribs 90 may be defined on an internal surface 92 of the rear cover 80, and which respectively engage upper cavities or notches 94 and side cavities or notches 96 defined on the core frame structure 14. In some example embodiments, the rear cover 80 may be secured to the second end 34 of the core frame structure 14 via a screw 98 that is inserted through screw recesses 100 defined in the rear cover 80 and correspondingly in the arc 62 of the charging receptacle 38. Removal of the screw 98 may allow for removal of the rear cover 80 and access to the second end 34 of the core frame structure 14.

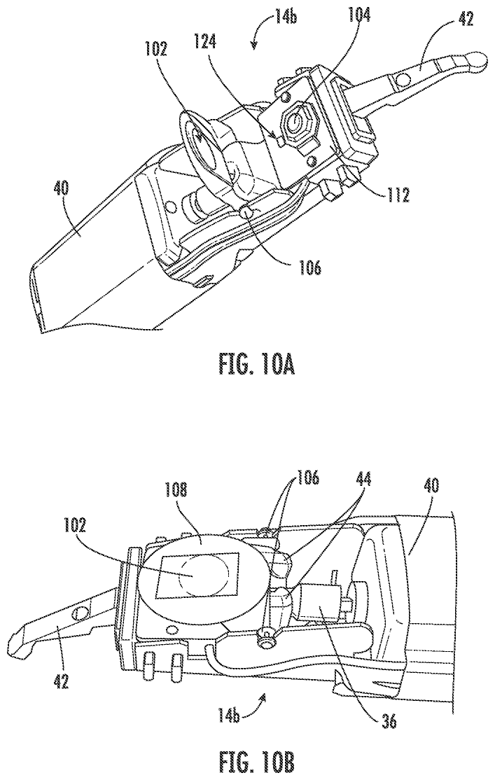

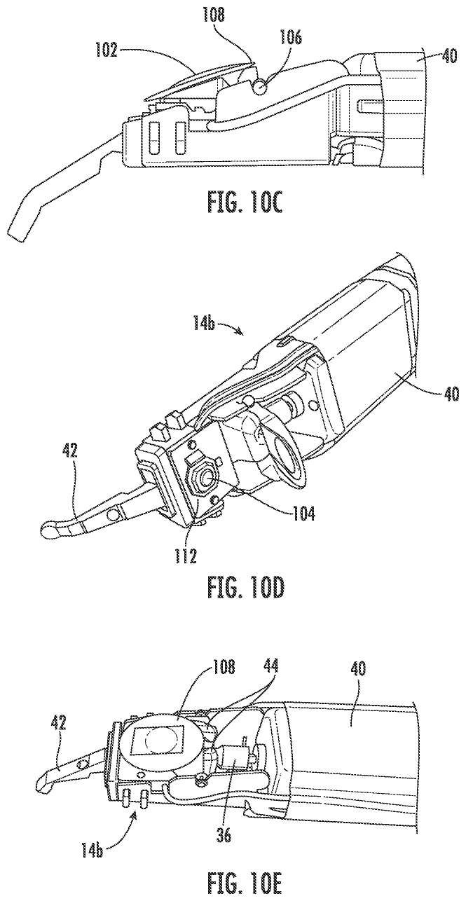

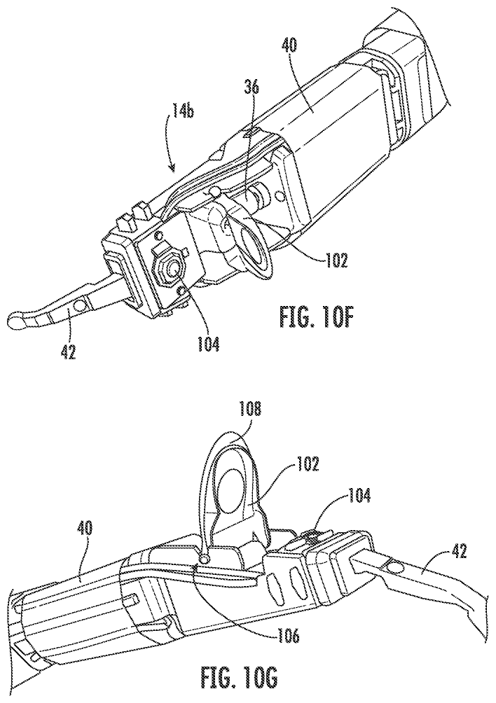

Referring now to FIGS. 10A-10H, detailed views of the first end 32 of the core-frame structure are illustrated. For example, as illustrated in FIG. 10A, the core frame structure 14 further comprises another element of an actuator 102 arranged toward the first end 32 of the core frame structure 14 in the front portion 14b. Force applied to the actuator 102 may alter an operating condition of the hair removal apparatus 10. An operating condition may be a mode that the hair removal apparatus 10, such as “ON” mode, “OFF” mode, etc. For example, in a first operating condition or an “ON” mode, a first instance of force application to the actuator 102 may cause electrical current to flow from the power source 46 to the motor 40 so as to actuate the motor 40. In this example, in a second operating condition or an “OFF” mode, a second instance of force application to the actuator 102 may cause the electrical current to cease to flow from the power source 46 to the motor 40 so as to de-actuate the motor.

A power switch 104 may be coupled (e.g., mechanically or electrically-connected) to the actuator 102 for controlling the flow of the electrical current from the power source 46 to the motor 40 in response to the application of force to the actuator 102. For example, the actuator 102 may be hinged such that the application of force to the actuator 102 causes the actuator 102 to hingedly rotate about a hinged axis (e.g., an axis of a hinge 106) and depress the power switch 104 so as to control the flow of the electrical current from the power source 46 to the motor 40. A masking layer 108 comprising a substantially opaque or light blocking material may be positioned above the actuator 102. One or more openings in the masking layer 108 may permit light to pass through the masking layer. In one example embodiment, the light blocking material of the masking layer 108 is a light-blocking tape that extends over an opening defined in a first layer 20 of the shell 12, whereas in other example embodiments, the masking layer 108 is formed from a portion of the first layer 20 of the shell 12.

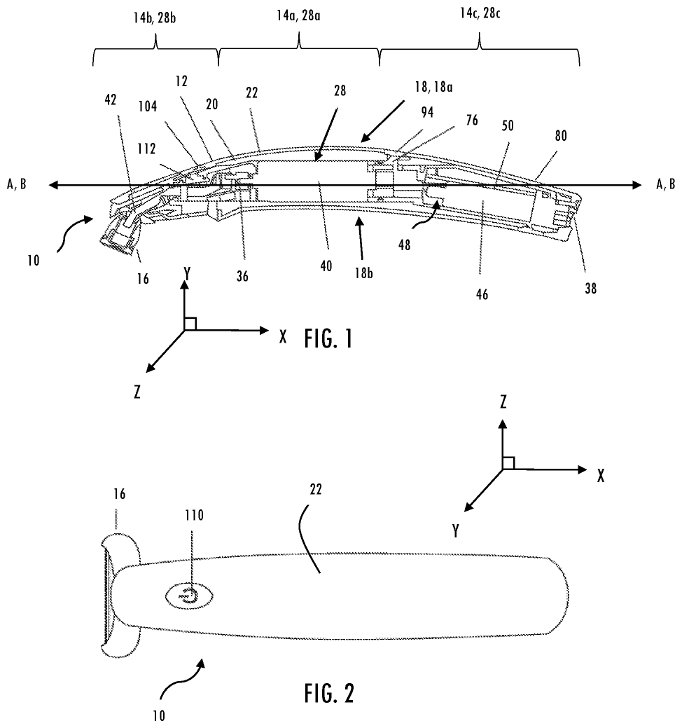

As illustrated in FIG. 2, a portion of the second layer 22 is aligned with the actuator 70 and defines a substantially translucent region 110. The substantially translucent region 110 may be formed so that the second layer 22 has a reduced wall thickness aligned with one or more openings in the first layer 20. The substantially translucent region 110 may be embossed, stamped, or otherwise formed so as to indicate the “power button” to a user, which corresponds to the location of the actuator 102. The actuator 102 may be aligned with the substantially translucent region 110, such that application of force to the substantially translucent region 110 of the second layer 22, will result in force applied to the actuator 102 and thereby the power switch 104. Advantageously, the arrangement of the power switch 104 under the substantially translucent region 110 seals the power switch 104 underneath the second layer 22, so that the power switch 104 and associated electrical components remain waterproof.

The power switch 104 may be a multi-functional touch switch that is mounted for multi-mode circuit control on a second circuit board 112 arranged toward the first end 32 of the core frame structure 14 in the front portion 14b. The second circuit board 112 may be in electrical connection with the first circuit board 50, and the first circuit board 50 and/or the second circuit board 112 may be in communication with the one or more of the power source 46, the motor 40, the charging receptacle 38, one or more peripheral elements, and the power switch 104.

In some example embodiments, the power switch 104 is formed from an opening in the first layer 20 and an extension having an arm with a circular end formed from a rigid material extends into the opening, while the second layer 22 covers the opening and the extension. In some other example embodiments, and as illustrated in FIGS. 10A-10H, the power switch 104 is a push button tact switch, such that the number of times that the power switch 104 is depressed corresponds to a different function or operating condition of the control circuit on the second circuit board 112. Each operating condition or function of the control circuit may correspond to a different output power of the motor 40. As such, the number of times that the power switch 104 is depressed may determine the output power of the motor 40 and the mode of the hair removal apparatus 10 (e.g., “OFF” in a second operating condition, “ON” in a second operating condition). However, the power switch 104 may be any other type of switch other than a multi-function push button tact switch, such as a rotary switch, a multi-position slide switch, a pressure-sensitive switch, a capacitive or inductive switch, etc.

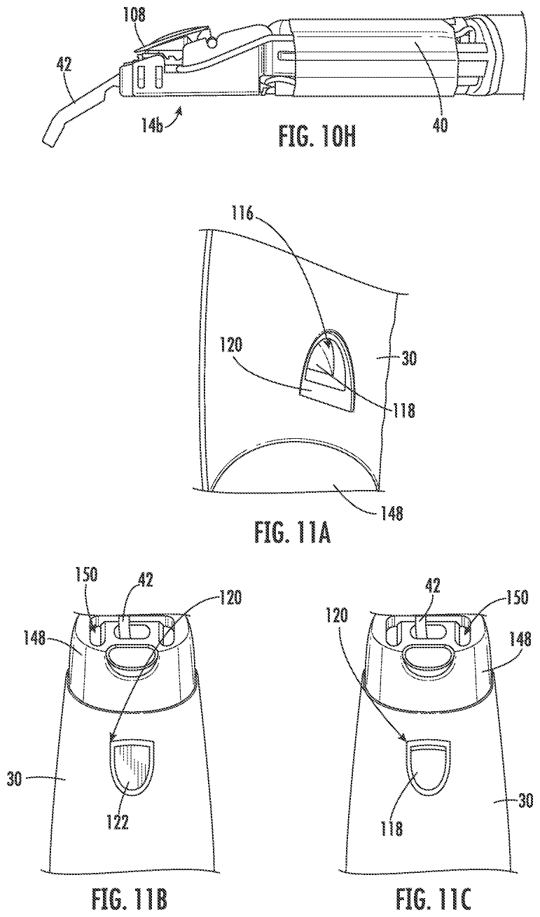

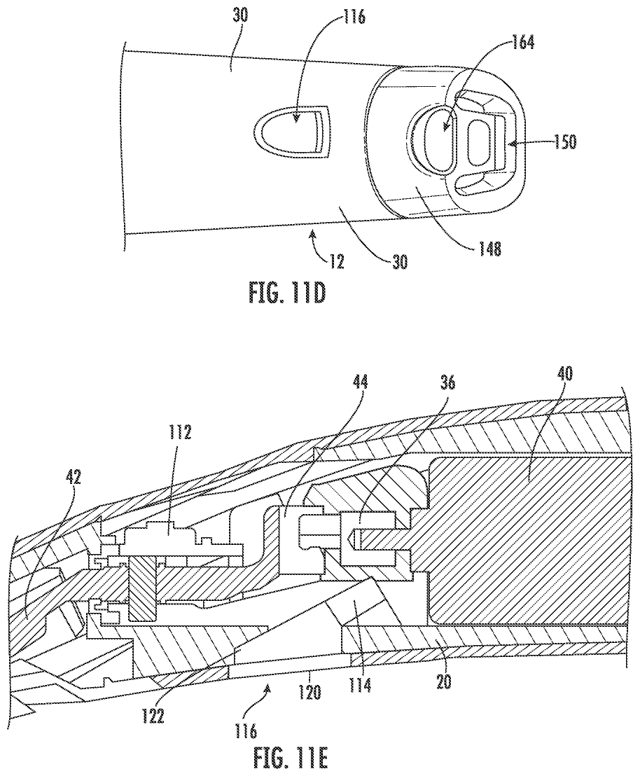

The power source 46 may be in electrical and/or mechanical communication with one or more peripheral elements such as, for example, light source(s) (e.g., light elements such as LEDs), indicator(s), sensor(s), timer(s), and the like. In some example embodiments, one of the peripheral elements is a first light source 114. As illustrated in FIGS. 11A-11E, the first light source 114 may be an LED arranged in the front portion 14b of the core frame structure 14 and electrically-connected with the power source 46 either directly or via the first circuit board 50. In response to the application of force applied to the actuator 102, the first light source 114 may provide illumination when the electrical current flows from the power source 46 to the first light source 114 in the first operating condition. An angled lighting cavity 116 may be formed between an angled surface 118 of the core frame structure 14 and the shell 12. The lighting cavity 116 may have a substantially transparent window 120 arranged on the outer surface of the shell 14 so as to direct the illumination along the angled surface 118 of the core frame structure 14 and through the substantially transparent window 120 toward the blade assembly 16, to thereby illuminate a surface of a user's body where the hair removal apparatus 10 is being used. A reflective treatment or coating 122 may be applied to the angled surface 118 of the core frame structure 14 to reflect the illumination from the angled surface 118 of the core frame structure 14 toward the blade assembly 16. The reflective coating 122 may be a piece of reflective silver tape, a high polished plastic material, hot stamping material of the angled surface 118, paint, electroplating of the angled surface 118, vacuum deposition on the angled surface 118, and/or another surface material capable of minimizing light absorption and reflecting light toward the substantially transparent window 120.

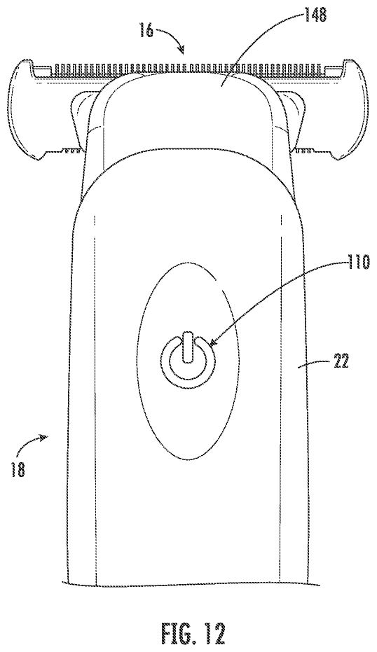

A second light source 124 may be mounted on the second circuit board 112 and electrically-connected with the power source 46 either directly or via the electrical circuit formed between the first circuit board 50 and the second circuit board 112. The second light source 124 may be arranged adjacent to or be integral with the power switch 104, wherein the portion of the shell 12 aligned with the actuator 102 defining the substantially translucent region 110 allows, in response to the application of force to the actuator 102, illumination from the second light source 124 to pass through opening(s) in the masking layer 108 to illuminate the substantially translucent region 110 from the internal cavity 28, where the illumination is visible through the outer surface of the shell 12 and provides an indication of the hair removal apparatus 10 being powered on (e.g., in an “ON” mode in the first operating condition), as illustrated in FIG. 12. More particularly, the portion of the shell 12 aligned with the actuator 102 includes a portion of the first layer 20 that defines an opening and the substantially translucent region 110 is a portion of the second layer 22 that is substantially translucent such that the illumination from the second light source 124 illuminates the translucent region 110 of the second layer 22 from the internal cavity 28 and through the opening in the first layer 20 so that the illumination is visible through the outer surface of the shell 12 and provides an indication of the hair removal apparatus 10 being powered on in the first operating condition. In this manner, a back-light configuration may be provided, which is sealed against the entry of debris, water, and other foreign materials.

In some example embodiments, the illumination of the second light source 124 (and/or the first light source 114) has a cycling sequence (e.g., is intermittent or flashing) during charging of the power source 46 through the charging receptacle 38, even if the hair removal apparatus 10 is in an “OFF” mode in the second operating condition. A similar or different type of cycling sequence for one or both of the second light source 124 and the first light source 114 is contemplated to indicate that the power source 46 of the hair removal apparatus 10 needs charging and/or is charging. Various other visual indicators, such as color change, rapid flashing, slow flashing, constantly on, off and combinations thereof can be used with the second light source 124 and/or the first light source 114 so as to indicate function, mode, low battery, use, and charging.

Referring now to the blade assembly 16, example blade assemblies are described in U.S. Provisional Appl. No. 62/936,999 to Langberg, filed Nov. 18, 2019, and entitled “Articulating Blade Assembly for Hair Removal Device,” and U.S. Appl. Pub. No. 2018/0326602 to Khubani, which applications are hereby incorporated by reference in their entirety herein.

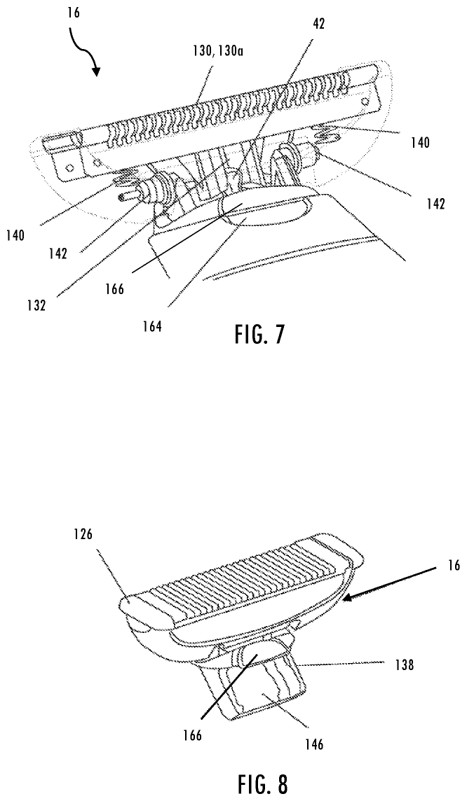

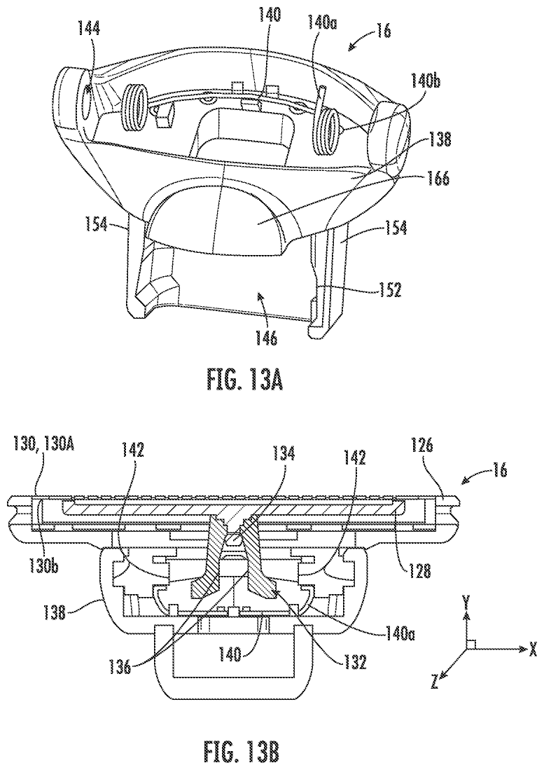

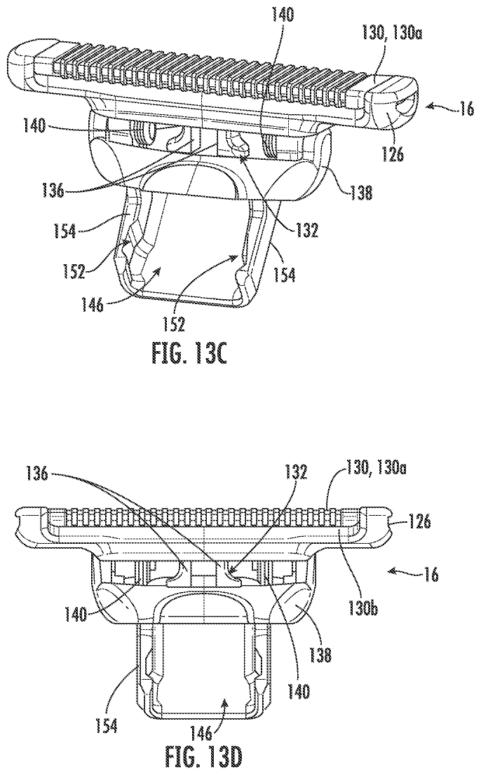

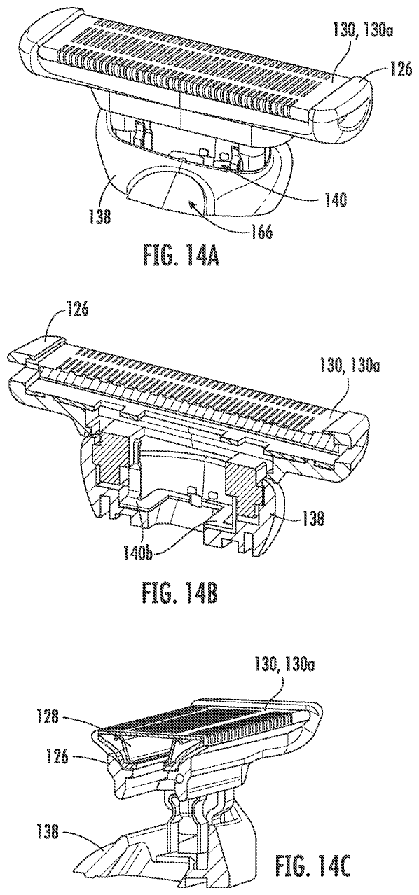

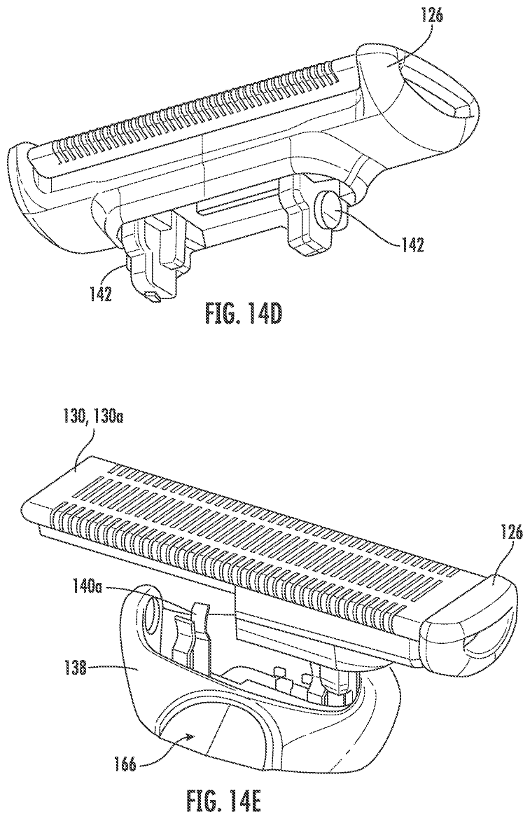

One example embodiment of the blade assembly 16 is shown, for example, in FIGS. 7 and 8, while FIGS. 13A-14E illustrate in greater detail example components of the blade assembly 16. Generally, the blade assembly 16 is engageable with the open front end 26 of the shell 12 and is enabled to bi-directionally travel or move in either of two opposing directions from an initial or equilibrium position relative to the handle 18 before returning to the initial or equilibrium position. The blade assembly 16 may comprise a blade housing 126 arranged to retain a moving blade 128 and a stationary blade 130. The moving blade 128 and/or the stationary blade 130 may be a metallic material and may be plated with another material. For example, the moving blade 128 and/or the stationary blade 130 may be 18 Karat gold plated, although other materials are contemplated as well. The stationary blade 130 may remain stationary while the moving blade 128 reciprocates in response to actuation of the motor 40. The stationary blade 130 may be molded (e.g., insert molded or otherwise coupled) with the blade housing 126 so that a top surface 130a of the stationary blade 130 contacts a user's skin while the hair removal apparatus 10 is in use. The moving blade 128 may be arranged on an opposing bottom surface 130b of the stationary blade 130 to laterally reciprocate relative to the stationary blade 130 when in the hair removal apparatus 10 is in use.

The blade assembly 16 may also comprise a transmission arm receiver 132 coupled to a protrusion 134 extending either directly from the moving blade 128 or from a moving blade housing in which the moving blade 128 is attached. As illustrated in FIGS. 7 and 13B, the transmission arm receiver 132 is coupled directly to the protrusion 134 extending from the moving blade 128. The transmission arm receiver 132 may define substantially parallel side walls 136 for receiving the transmission arm 42 therein. As used herein, “substantially parallel side walls” refers to at least a portion of the side walls 136 being parallel to one another. FIG. 7 shows the transmission arm 42 being received within or between the parallel portion of the side walls 136 of the transmission arm receiver 132. As the motor 40 and thereby the transmission 36 experiences rotary movement in response to actuation of the motor 40, the transmission arm 42 may laterally reciprocate against the parallel side walls 136 of the transmission arm receiver 132 so as to cause lateral reciprocation and a cutting or shaving motion of the moving blade 128 in the X-direction.

A connector frame 138 may be hingedly coupled to the blade housing 126 so that the blade housing 126 is hingedly moveable relative thereto. More particularly, the blade housing 126 may rotate about an axis of rotation defined by the hinged coupling from an initial or equilibrium position, during application of a force on the blade housing 126. For example, the blade assembly 16 is able to hingedly move from the initial position (FIG. 1) towards a top surface 18a of the handle 18 and from the initial position towards a bottom surface 18b of the handle 18. In another example, the blade assembly is able to hingedly travel from the initial position (FIG. 1) starting from the bottom surface 18b of the handle 18 towards the top surface 18a of the handle 18.

The blade housing 126 may be configured so that no restoring force is present in the initial or equilibrium position, whereas a biasing element 140, such as one, two, three, four, etc., springs, may interact with the blade housing 126 and/or the connector frame 138 to provide a restoring force to the blade housing 126 when application of the force to the blade housing 126 causes the blade housing 126 to rotate out of the initial or equilibrium position. In some example embodiments, a pivot structure on the blade housing 126 may interact with a corresponding pivot structure on the connector frame 138. More particularly, and as illustrated in FIGS. 13A-13D and 14A-14E, protrusions 142 facing outwardly on the blade housing 126 may be inserted within corresponding depressions 144 of the connector frame 138. The biasing element 140 may be two springs with first ends 140a that are biased against a portion of the blade housing 126 and second ends 140b that are biased against a portion of the connector frame 138. The springs of the biasing element 140 may thereby provide the restoring force to the blade housing 126 to hingedly rotate the blade housing 126 into the initial position. This hinged rotation allows the blade assembly to easily and efficiently glide over a user's skin and along the contours of the user's body, without having to change the angle at which the hair removal apparatus 10 contacts the user's body.

Where the biasing elements 140 are springs, the springs may be, for example, C-shaped, I-shaped, H-shaped, M-shaped, T-shaped, U-shaped, X-shaped, W-shaped or triangular shaped springs that each apply force. Such springs may be compression, extension, torsion, linear, variable rate, or constant force springs, using a variety of configurations such as coil springs, leaf springs, flat springs, machined springs, molded springs, or any combinations of the above. Other arrangements of springs may be used to form other geometric shapes that provide a restoring force.

The connector frame 138 may define a channel 146 aligned with the transmission arm receiver 132 and arranged to receive the transmission arm 42 therethrough, when the channel 146 is inserted into the open front end 26 of the shell 12 so as to engage the blade assembly 16 with the shell 12. Upon engagement of the blade assembly 16 with the open front end 26 of the shell 12 (and insertion of the core frame structure 14 within the shell 12), the transmission arm 42 may extend through the open front end 26 of the shell 12 and through the channel 146 of the connector frame 138. In use, the transmission arm 42 may laterally reciprocate against the parallel side walls 136 of the transmission arm receiver 132 to cause lateral reciprocation of the moving blade 128 in the X-direction in response to actuation of the motor 40. Therefore, when force is applied to the actuator 102, the electrical current is caused to flow from the power source 46 to the motor 40, so as to actuate the motor 40 and cause the moving blade 128 to laterally reciprocate relative to the length of the shell 12 when the blade assembly 16 is engaged with the open front end 26 of the shell 12.

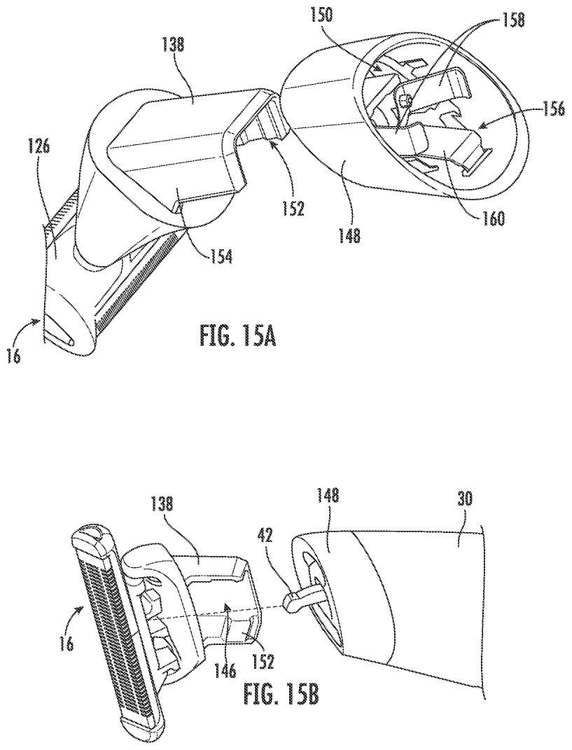

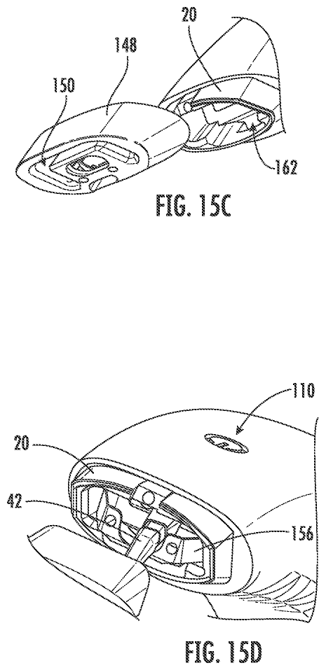

To releaseably secure or engage the blade assembly 16 with the open front end 26 of the shell 12, the connector frame 138 may engage a front ring 148, as illustrated in FIGS. 15A-15D. The front ring 148 may have a receiving opening 150 that engages the first layer 20 of the shell 12. The front ring 148, similar to the trim ring 82, may be rose gold in appearance and may cooperate with the second layer 22 to provide for a substantially waterproof seal at the open front end 26 of the shell 12. In particular, once the front ring 148 is engaged with the open front end 26 of the shell 12, the channel 146 may be inserted into the receiving opening 150 of the front ring 148. Notches 152 defined on opposing side walls 154 of the channel 146 (FIGS. 8, 13A, 13C, 13D) may be received by a resilient prong structure 156 (FIG. 15A) arranged about the open front end 26 of the shell 12. One example embodiment of the resilient prong structure 156 is illustrated in FIG. 15A, where the resilient prong structure 156 is in the form of spring clip side arms 158 formed on an inner side surface of the front ring 148 and a spring clip bottom arm 160 formed on the inner bottom surface of the front ring 148. Once the channel 146 is inserted into the receiving opening 150, the notches 152 of the channel 146 are engaged with and retained by the spring clip side arms 158, which then apply an outward pressure on the opposing side walls 154 of the channel 146. The spring clip bottom arm 160 is arranged to contact a corresponding open front end notch 162 defined on the open front end 26 of the shell 12 (FIG. 15C) and secure the front ring 148 to the open front end 26 of the shell 12. Alternatively, the blade assembly 16 may be pivotally attached, rotationally attached, magnetically attached, and/or any other attachment method to the shell 12 or transmission arm 42, or may be fixedly attached thereto.

To remove the blade assembly 16 from the open front end 26 of the shell 12, the outer surface of the shell 12 may comprise an ejection structure that in use, disengages the blade assembly 16 from the open front end 26 of the shell 12 to allow for cleaning of the blade assembly 16 and/or replacement thereof. The ejection structure may be a push button, a slide, or another mechanical arrangement. For example, and as illustrated in FIG. 7, the ejection structure may comprise a notch 164 defined on the outer surface of the shell 12 that corresponds to a similar notch 166 on the connector frame 138. Forced applied to the notch 164 on the outer surface of the shell 12, results in pushing the notches 152 of the channel 146 of engagement with the resilient prong structure, and thereby the connector frame 138 out of engagement with the receiving opening 150.

An improved articulating blade assembly 1010 is illustrated in FIGS. 16-22I. The improved articulating blade assembly 1010 may essentially replace a blade assembly 16 as already described above. Alternatively, a blade assembly 16 as described above may be reconfigured to incorporate one or more components of the improved articulating blade assembly 1010 that, as further described herein, are effective to provide one or more of the desired benefits achieved according to the present disclosure, such as consistent feel, dual rocking motion, self-positioning, and/or ease of assembly and reassembly after separation.

As will be further evident from the following description of the various components of the device, the improved articulating blade assembly beneficially provides one or more advantages over known blade assemblies that provide for a more robust, durable, and easy to use device. For example, the articulating blade assembly can be configured such that the blade assembly will disengage from the mount component if sufficient force is applied, such as if the overall device is inadvertently dropped by a user. This can prevent breakage of the articulating blade assembly due the drop force. Moreover, the blade assembly may be easily re-engaged with the mount by a user without significant difficulty. This disengagement/reengagement feature can be achieved by the specific configuration of the drum and matching recess as described below. As another example, the blade assembly can be configured to exhibit a static neutral position or resting position. Moreover, the blade assembly can be moved or rotated away from the neutral position by application of force (e.g., an externally applied force), such as encountered during use of the blade assembly. The application of such force can automatically stimulate or enable a restoring force (e.g., an internally applied force) that is provided by one or more biasing elements present in the blade assembly. The restoring force can be sufficient to return the blade assembly to the neutral position once the externally applied force is removed. A plurality of biasing elements can be utilized and configured to provide opposing forces so that the blade assembly will pivot in two directions and will be biased back to the neutral position from either direction. In this manner, an articulating blade assembly 1010 as disclosed herein is enabled to move in either of two opposing directions from a neutral position relative to a handle and return to the neutral position.

Referring now to the figures, the articulating blade assembly 1010 includes a blade housing 1020, having a front surface 1021 with a first edge 1021a and a second edge 1021b, a rear surface 1023, a first end 1027, and an opposing second end 1029. A pair of blade pivot structures (collectively formed of a first blade pivot structure 1030a and a second blade pivot structure 1030b) can be arranged on an uprising 1024 present on the rear surface 1023 of the blade housing 1020. A first blade pivot structure 1030a is circled in FIG. 18 for illustration purposes, it being understood that the second labeled blade pivot structure 1030b is substantially identical thereto. As illustrated in FIG. 18, the first blade pivot structure 1030a can comprise a substantially cylindrical first drum 1031 extending therefrom toward one end (i.e., a first end) of the blade housing 1020 and a substantially cylindrical second drum 1033 extending toward the other end (i.e., a second end) of the blade housing 1020. The first drum 1031 and second drum 1033 each have a diameter, including a center point, and an axis of rotation is defined along a longitudinal line extending between the two center points. As such, the drums (1031, 1033) are separate elements (i.e., non-contiguous) that are aligned to establish the axis of rotation without requiring a single element extending completely along the axis from end-to-end. The blade pivot structures (1030a, 1030b) are each arranged such that distances between the respective ends (1027, 1029) of the blade housing 1020 and the respective faces (1032, 1033) of the drums (1031, 1033) are substantially equal. Thus, the blade pivot structure specifically may comprise two elements spaced away from a center line of the blade housing 1020 (e.g., a line that is substantially transverse to the longitudinal axis of the blade housing), with the first element comprising the first drum and the second element comprising the second drum. If desired, however, the blade housing can be configured so that a single unified element is utilized as the blade pivot structure.

As seen from the foregoing, the blade housing 1020 can extend longitudinally from a first end 1027 to an opposing second end 1029 and can comprise a front surface 1021 and an opposing rear surface 1023. As seen in FIG. 18 particularly, the rear surface 1023 can extend upward from each of the first end 1027 and the opposing second end 1029 to form or provide drums (1031, 1033) having outer faces (1032, 1034) extending away from one another and to form or provide force-receiving structures (1036, 1037) extending upward and parallel to one another. The force-receiving structures (1036, 1037) thus can be substantially linearly shaped and can be substantially parallel to one another in that they each extend away from the rear surface 1023 so as to be substantially perpendicular to the front face 1021 of the blade housing 1020. In other embodiments, however, the force-receiving structures (1036, 1037) need not be positioned perpendicularly to the front face 1021 of the blade housing 1020 and rather may be at an acute angle or an obtuse angle relative to the front face 1021 of the blade housing 1020.

The force-receiving structures (1036, 1037) can each comprise a force-receiving surface, and the force-receiving surfaces can be substantially co-planar with one another. For example, the force receiving surface may be the terminal ends that are evident on the top of the force-receiving structures (1036, 1037) in FIG. 18. Alternatively, the force receiving surface may be on sides of the force-receiving structures (1036, 1037) that face the first edge 1021a and/or the second edge 1021b of the blade housing 1020.

The at least one force receiving structure of the blade housing 1020 can be configured to accept a restoring force during movement of the articulating blade assembly and thereby urge the blade assembly toward the neutral position. The force receiving structure may be integral to the blade housing 1020 (e.g., as already described above), integral to one or more pivot structure(s), or comprise a separate component. As illustrated in FIG. 18, a first force receiving structure 1036 and a second force receiving structure 1037 are individually adjacent to or abutting the first drum 1031 and the second drum 1033, respectively. In some embodiments, a respective drum of a respective force receiving structure may be monolithic in that the drum and force receiving structure are configured as a single, combined element.

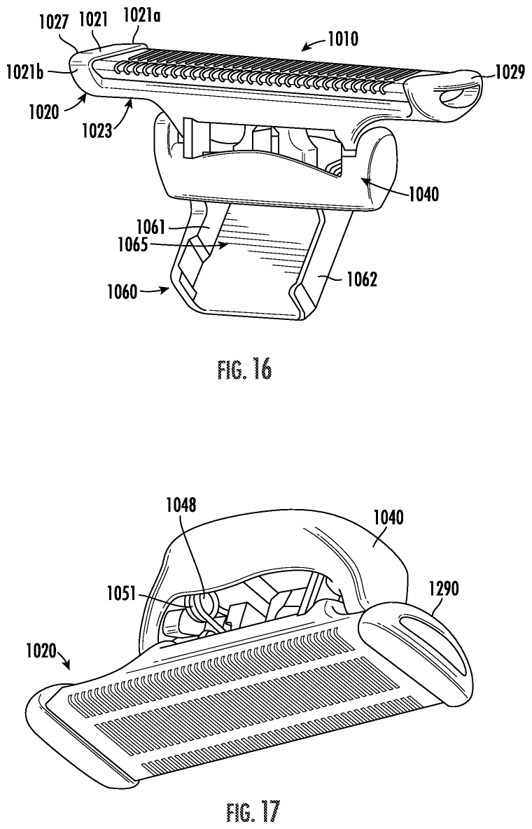

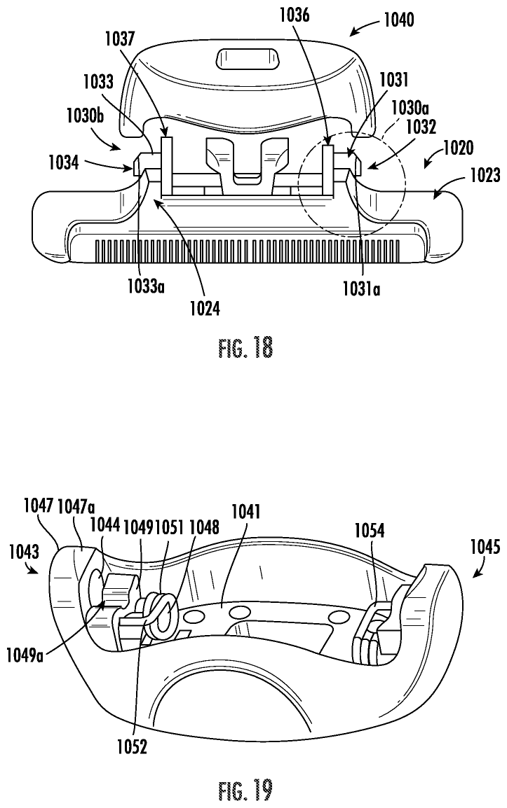

The articulating blade assembly further comprises a mount 1040 configured to mate with the blade housing 1020 via the pivot structure(s) 1030. The mount 1040 may particularly be configured to rotationally engage the blade housing 1020 along the axis of rotation. The mount 1040 may be formed from any suitable material, such as plastic, metal, wood, or the like. Likewise, the blade housing 1020 may be formed from any suitable material, such as plastic, metal, wood, or the like. As further illustrated in FIGS. 19-21, the mount 1040 comprises a first engagement structure 1043 (circled in FIG. 21 for ease of reference) and a second engagement structure 1045, each extending from a base portion 1041 and each comprising a pivot recess 1044. The first and second engagement structures (1043, 1045) are spaced apart and each configured to receive at least a portion of the first drum 1031 and the second drum 1033, respectively, into the respective pivot recesses 1044. The engagement between the first drum 1031 and the matching pivot recess 1044 and between the second drum 1033 and the matching pivot recess 1044 can be such that the outer faces (1032, 1034) of the drums (1033, 1035) are abutting or otherwise contacting a bottom surface 1044a of the pivot recess 1044. As illustrated in FIG. 19 through FIG. 21, the mount 1040 can include an opening 1042 through the base portion 1041. The opening 1042 can provide for passage therethrough of one or more functional elements from the handle of the hair removal apparatus 10 described above. For example, the transmission arm 42 can extend through the opening 1042 in the mount 1040 to engage with the blade apparatus.

A force transmitting element or biasing element 1051 is configured with at least one constrained end or portion 1052 and at least one moving end or portion 1054, wherein the moving portion(s) is/are configured to contact the force receiving structure (1036, 1037) when the blade housing 1020 is assembled to the mount 1040. The force transmitting or biasing element 1051 can be configured to have a first portion (e.g., the moving portion 1054) biased against the blade housing 1020 (or a portion thereof) and a second portion (e.g., the constrained portion 1052) biased against the mount 1040 (or a portion thereof) such that pivoting of the blade housing about the axis of rotation causes the first portion biased against the blade housing to exert an opposing force upon the blade housing. In various embodiments, the force transmitting or biasing element 1051 can be formed integrally with the mount 1040 or can be separable and/or attachable to the mount or a portion thereof.

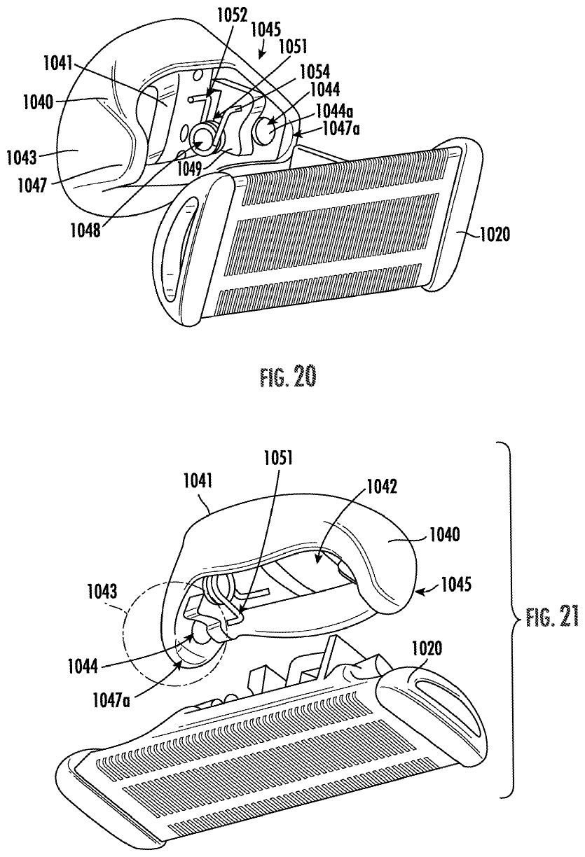

In the example embodiment shown in FIG. 20, the force transmitting or biasing element 1051 can comprise a coiled spring configured to slide around a pin 1048 extending inwardly from the second engagement structure 1045, although other configurations are envisioned depending upon the exact nature of the force transmitting or biasing element 1051. Additionally, one or more reinforcing structures may be present within the mount, particularly on the engagement structures (1043, 1045). For example, a wall 1049 may extend inwardly from the engagement structure(s) (1043, 1045) and may be positioned adjacent the pin 148. The wall structure 1049 can provide an engagement for the constrained portion 1052 of the force transmitting or biasing element 1051. The wall structure 1049 likewise can provide structural support to the mount 1040 so that the engagement structures (1043, 1045) are strengthened to prevent breakage during engagement/disengagement of the blade housing 1020 with the mount 1040. The wall structure 1049 can include a recessed portion 1049a proximate to the pivot recess 1044, and the recessed portion 1049a of the wall structure 1049 can be effective to direct the drums (1031, 1033) into the pivot recess 1044 formed in each of the engagement structures (1043, 1045).

As can be seen from the foregoing, the mount 1040 can extend longitudinally from a first end to an opposing second end (e.g., in the same direction as the blade housing 1040 between the first end 1027 and the opposing second end 1029). The first end and the opposing second end of the mount 1040 can correspond substantially with the first engagement structure 1043 and the second engagement structure 1045, respectively. Each of the first end and the opposing second end of the mount 1040 can define a drum recess, which can correspond to the pivot recesses 1044 described above. As such, the drums (1031, 1033) of the first end and the opposing second end of the blade housing 1020 can be arranged to engage respective drum recesses of the first end and the opposing second end of the mount and define the axis of rotation. More particularly, the axis of rotation can correspond to a line extending from a substantially central point in the drum recess or pivot recess 1044 configured in the first engagement structure 1043 to a substantially central point in the drum recess or pivot recess 1044 configured in the second engagement structure 1045 or, in other words, a line extending between the drum recesses in the respective ends of the mount 1040 (e.g., as defined by the engagement structures 1043 and 1045). The first end and the opposing second end of the mount each further can comprise a pin having an outer face (as already described above) such that the outer faces of the pins (1048) extend toward one another. In other words, the outer faces of the pins 1048 are oppositely faced from one another and can be substantially aligned in a parallel fashion. As also pointed out above, the force transmitting or biasing element 1051 can be a torsion spring having a coiled central portion arranged between the first portion and the second portion (e.g., arranged between the moving portion 1054 and the constrained portion 1052) and arranged about a respective one of the pins 1048. Further, the first portion can define a moving end biased against the blade housing 1020, and the second portion can define a constrained end biased against the mount 1040 such that pivoting of the blade housing about the axis of rotation causes the first portion to exert the opposing force against the blade housing. The constrained end (e.g., constrained portion 1052) can be biased against a top surface of the mount 1040. Referencing FIG. 19, the top surface of the mount 1040 can be surface of the base portion 1041 that is interiorly facing and is seen in FIG. 19. The moving end (e.g., moving portion 1054) can be biased against the respective force-receiving structure (1036, 1037) of the blade housing 1020. In this manner, pivoting of the blade housing 1020 about the axis of rotation causes the moving ends 1054 of the torsion springs to exert an opposing force upon the respective force-receiving structures (1036, 1037). To enable a counterbalancing effect that causes the blade assembly to return to the neutral position from forced rotation in one of two opposing directions, a pair of force transmitting or biasing elements 1051 can be present and can be oppositely arranged in reference to the engagement of the moving end 1054 and the constrained portion 1052. Thus, the moving end 1054 of one biasing element 1051 can move to rotate the blade assembly in one direction, and the moving end of a second biasing element can move to rotate the blade assembly in a second, opposing direction. Otherwise stated, the two biasing elements can be configured to establish a force that opposes rotation in opposing directions and thus will cause the blade assembly to rotate back to the neutral position regardless of the direction of an applied, external force that has previously cause the blade assembly to rotate away from the neutral position. As such, the articulating blade assembly, in some embodiments, specifically can comprise two torsion springs and two pins, each of the torsion springs having the coiled central portion arranged about the respective one of the two pins. In some embodiments, the biasing elements 1051 can be arranged so as to specifically be non-concentric with the axis of rotation.

The engagement structures (1043, 1045) of the mount 1040 can have a rounded terminal end 1047 that can include a sloped portion 1047a. The rounded nature of the terminal end 1047 can encourage the pivot structure and increase smoothness of the pivot. Likewise, the sloped portion 1047a can advantageously improve the ability of a user to easily engage an articulating blade assembly 1010 with the mount 1040 by biasing the drums (1031, 1033) toward the pivot recess 1044 formed in the engagement structures (1043, 1045). The drums (1031, 1033) can include matching sloped sections (1031a, 1033a). Specifically, the respective sloped or slanted portions of the engagement structures (1043, 1045) and the respective sloped or slanted portions of the drums (1031, 1033) can be directionally matched. The slant or slope of the drums and the terminal ends of the engagement structures can improve the ease of sliding a new articulating blade assembly 1010 into a secure engagement with the mount 1040 so that the engagement structures are encouraged to flex outward to allow the drums of the articulating blade assembly to securely lock into the pivot recesses. As the sloped or slanted portions of the drums engage the sloped or slanted portions of the engagement structures, the ends of the respective drums slide past the ends of the engagement structures to cause the engagement structures to flex outwardly and allow the drums to engage the recesses formed in the engagement structures, at which time the engagement structures will return to a non-flexed position wherein the blade assembly 1010 is securely engaged with the mount 1040. This can be characterized as a snap-fit engagement. As described above, this engagement can securely position the blade assembly in the mount but allow the blade assembly to be disengaged from the mount through application of a sufficient force, such as a force resulting from dropping the device. The installation method outlined above can make re-assembly relatively simple and quick for a user of the device.

The articulating blade assembly 1010 is configured to rotate about an axis of rotation, during application of a force on the first edge 1021a or the second edge 1021b, causing the force receiving structure(s) (1036, 1037) to move relative to the constrained portion 1052 of the force transmitting or biasing element 1051. Movement of the force receiving structure(s) (1036, 1037) causes the moving portion 1054 of the force transmitting or biasing element 1051 to move relative to the constrained portion 1052, creating a restoring force in the force transmitting element 1051. The restoring force is applied by the force transmitting element 1051 to the force receiving structure(s) (1036, 1037) in the opposite direction of the movement of the force receiving structure(s) (1036, 1037).

As previously described above, the force transmitting or biasing element 1051 can comprise at least two moving portions 1054, which may extend from a common constrained portion 1052 or may each extend separately from an individual constrained portion. In some embodiments, the two moving portions 1054 may be arranged to exert forces on opposite sides of a single force receiving structure (1036 or 1037). Alternatively, one moving portion 1054 may be arranged to exert a force on a first force receiving structure 1036 in a first direction and a second moving portion may be arranged to exert a second force on a second force receiving structure 1037 in a second direction opposite the first direction. In this manner, two restoring forces of opposite directions exerted on one or more force receiving structures may return the articulating blade assembly to a neutral position. The articulating blade assembly 1020 may be configured so that no restoring force is present in the neutral position, or may be configured such that equal and opposite restoring forces are applied by the force transmitting elements in the neutral position. As such, the blade housing 1020 can be configured to be pivotable about the axis of rotation in either of two opposing directions from an initial position. Preferably, the blade housing 1020 is biased to a neutral position (i.e., the initial position) so as to be automatically repositioned to the neutral position when any force causing the blade housing to pivot in one of the two opposing directions is removed.

The drums (1031, 1033) and recesses 1044 are configured to enable the articulating blade assembly 1020 to be separated without damage or tools and reassembled without damage or tools. In an embodiment, the drums (1031, 1033) and recesses 1044 form a snap fit, a press fit, a magnetic fit, or similar arrangement relative to one another. For example, for a magnetic fit, the drums may comprise a magnetic element and/or the recesses formed in the mount may comprise a magnetic element.

Force transmitting elements 1051 may comprise a variety of structures such as coil springs, leaf springs, other spring types, elastomeric materials, pneumatic configurations, magnetic elements, electromagnetic elements, etc. Any material, mechanism or structure effective to generate a restorative force throughout the movement range may be used. The force transmitting elements may be used to modify an existing blade assembly, such as, for example, the blade assembly of Appl. Ser. No. 62/923,374 and Ser. No. 15/932,888, incorporated by reference in their entirety herein.

In one example embodiment, the force transmitting or biasing structure 1051 can comprise two coiled springs, each retained on a pin 1048 and secured in the mount 1040. The pins 1048 can be offset from the axis of rotation. The springs and corresponding pins are configured on opposite sides of the axis of rotation, with a lever arm extending past the axis of rotation to a contact point of a force receiving structure(s) (1036, 1037). In this arrangement, the coil for each spring is on the opposite side of the axis of rotation from the force receiving structure (1036, 1037) aligned with each lever arm. As the blade head rotates in a first direction, the force receiving structure (1036, 1037) toward the direction of rotation pushes the lever arm, causing movement of the lever arm relative to the coil. It is understood that a lever arm as referenced above can specifically be the moving portion 1054 of the force transmitting or biasing element 1051.

The location of the biasing structure 1051 so as to be substantially off the axis of rotation (i.e., non-concentric with the axis of rotation) allows for the utilization of drums with a significantly shortened length and an increased diameter relative to known devices. This, in addition to securing the biasing structure to the coupling element, can significantly increase the overall strength of the coupling elements and reduce or eliminate breakage during a drop test. Likewise, if the blade assembly and coupling element do separate during drop, it is relatively simple for a consumer to reassemble as described above since the biasing structures don't need to be pre-tensioned in order to properly function.

As illustrated in the example embodiment of FIG. 18, the force receiving structure (1036, 1037) can be configured as a wall or rib extending away from its respective drum (1031, 1033), which is functional as a blade pivot structure. The wall or rib structure forming the force receiving structure (1036, 1037) can particularly extend radially from the axis of rotation in a direction away from the rear surface 1023. In one example embodiment, a wall or rib extends radially from the axis of rotation toward the rear surface. Restoring force is applied to opposing surfaces of the wall or rib by one or more force transmitting elements. In one example embodiment, restoring force is applied to a central point of a wall, rib, or other attachment structure.

Returning to FIG. 16, the articulating blade assembly 1010 can further include a handle adapter 1060 that extends outward from the mount 1040. The handle adapter 1060 can include a pair of longitudinal walls (1061, 1062) that define a channel 1065. The channel 1065 can be effective to guide the transmission arm of the hair removal apparatus 10 into a working engagement with the moving blade of the articulating blade assembly 1010. The handle adapter 1060 may be integrally formed with the mount 1040 (e.g., the handle adapter and the mount being a monolithic piece or being at least two pieces that are permanently attached) or may be removably attached thereto (e.g., by a friction fit, a magnetic engagement, or the like) so that the handle adapter and the mount are engaged with one another. In this manner, the handle adapter 1060 can be engaged with the mount 1040 and aligned with a centrally-defined opening 1042 in the mount 1040 so as to engage a device body of the hair removal device. The handle adapter 1060 may be at least partially inserted into the centrally-defined opening 1042 or may engage a portion of the mount 1040 around the opening. The handle adapter 1060 thus assists in aligning the articulating blade assembly 1010 with the corresponding connecting elements of the device body (e.g., the shell 12). The handle adapter 1060 thus may function substantially similarly to the connector frame 138 that engages a front ring 148 of the shell 12, as illustrated in FIGS. 15A-15D.

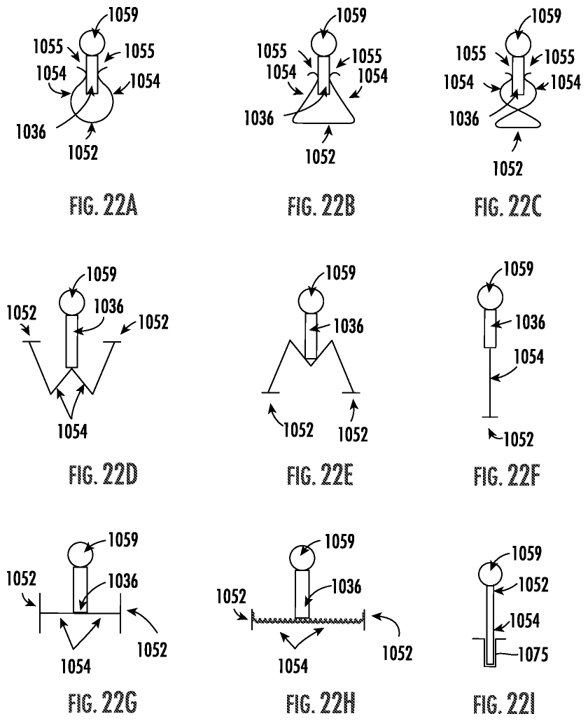

FIG. 22A through FIG. 22I illustrate various example embodiments of configurations for interactions between the force transmitting or biasing structure 1051 and the force receiving structure(s) (1036, 1037). In FIG. 22A, the force transmitting or biasing structure 1051 can have substantially round or C-shaped such that the constrained portion 1052 is substantially oppositely positioned from the force receiving structure 1036 with the moving portion 1054 extending away from the constrained portion in an arcuate or curved configuration to abut the force receiving structure 1036. Lead-in members 1055 are formed at the ends of the force transmitting or biasing structure 1051 abutting the force receiving structure 1036 and are substantially oppositely curved relative to the moving portion 1052 to provide for rotating movement against the force receiving structure 1036 while the articulating blade assembly 1020 rotates about the axis of rotation 1059. FIG. 22B illustrates a similar embodiment, but in the illustrated embodiment, the constrained portion 1052 of the force transmitting or biasing structure 1051 is substantially flat and transitions to the moving portion 1054 (which is also substantially flat) via an angled section such that constrained portion 1052 and the moving portion 1054 form a substantially acute angle relative to one another. FIG. 22C illustrates a further iteration of this configuration but wherein the force transmitting or biasing structure has a substantially hourglass shape. The constrained portion 1052 is again substantially flat and transitions to the moving portion 1054 through a substantially acute angle, but the two moving portions 1054 cross over so that the lead-in member 1055 of a given moving portion is on the opposing side of the force receiving structure 1036 relative to the angled transition section between the constrained portion 1052 and the given moving structure 1054.

FIG. 22D and FIG. 22E illustrate example embodiments wherein the force transmitting or biasing structure 1051 is substantially W-shaped or substantially M-shaped, respectively. In FIG. 22D, the constrained portion 1052 is anchored proximate to the force receiving structure 1036 and extends away from the force receiving structure to an angled transition. The two moving portions 1054 extend away from the angled transition and toward the force receiving structure 1036 to make contact therewith. Conversely, in FIG. 22E, the constrained portion 1052 is anchored distal from the force receiving structure 1036 and extends toward the force receiving structure to an angled transition. The two moving portions 1054 extend away from the angled transition and merge proximate to an end of the force receiving structure 1036.

In FIG. 22F, the constrained portion 1052 is anchored distal from the force receiving structure 1036. The moving portion 1054 extends from the constrained portion to contact the force receiving member. The moving portion 1054 can be configured as a spring so that rotation about the axis of rotation 1059 bends the spring, and removal of force from the articulating blade assembly 1020 allows the force exerted by the spring to return to the neutral position. FIG. 22G provides a similar embodiment. Specifically, the constrained portions 1052 are anchored laterally from the force receiving structure 1036, and the moving portion(s) 1054 extending between the constrained portions in a substantially straight line such that an end of the force receiving structure 1036 is anchored to a middle section of a single moving portion 1054 or to end sections of separate moving portions 1054. In this manner, rotation about the axis of rotation cause the moving portion(s) 1054 to deform and then spring back to the neutral position once force exerted on the articulating blade assembly 1020 ceases. In some embodiments, the entire constrained portion 1052 can be anchored, but in other embodiments, the constrained portions 1052 may be configured such that they or only anchored at the ends of each constrained portion. In such embodiments, the constrained portions may be flexible so that rotation about the axis of rotation can cause and intermediate section of the constrained portion 1052 to deform and then spring back as noted above. FIG. 22H illustrates a substantially similar embodiment but wherein the moving portion 1054 is configured as a coiled spring or a pair of coiled springs. As such, the force receiving structure 1036 can be connected to an intermediate section of s single moving portion 1054. Alternatively, two moving portions 1054 may be utilized, and the ends of the two moving portions can be connected to the force receiving structure. In FIG. 22H, the specific connection between the force receiving structure 1036 and the moving portion(s) 1054 is not expressly shown since both options described above are intended to be encompassed by the illustration. In yet another embodiment, as seen in FIG. 22I, the constrained portion 1052 can be in contact with the axis of rotation or with a force receiving structure extending therefrom. The moving portion 1054 can extend therefrom to engage a slot 1075 present in, for example, the mount 1040. In this configuration, an end of the moving portion 1054 positioned in the slot becomes substantially stationary so that rotation of the articulating blade assembly 1020 about the axis of rotation 1059 cause the moving portion to bend and then bias the articulating blade assembly 1020 back to a neutral position once force exerted on the articulating blade assembly 1020 ceases.

The various configurations illustrated in FIG. 22A through FIG. 22I (inclusive of further embodiments that are derivable therefrom) the force transmitting or biasing structure 1051 may be formed from any type of spring, including compression, extension, torsion, linear, variable rate & constant force springs, using a variety of configurations such as coil springs, leaf springs, flat springs, machined springs, molded springs, or by combinations of the above. Other arrangements of springs may be used to form other geometric forms that provide equal and opposite motion with equal and opposite restoring force. In one example embodiment, magnets are used instead of mechanical springs to provide the restoring forces. Motion of the pivot around the axis of rotation causes increases and decreases in magnetic field strength due to arrangement of magnetic elements, wherein magnetic repulsion acts like a spring or springs to urge the blade assembly back to a neutral position.

Securing of the force transmitting or biasing element 1051 can be arranged to allow significantly more movement of the moving portion in comparison to the movement of the constrained portion. As such, in some embodiments, the constrained portion 1052 may still experience some degree of motion, but such motion is less than the motion caused in the moving portion 1054.

A force transmitting or biasing element 1051 may be a separable component from the mount 1040. In other embodiments, however, the force transmitting or biasing element 1051 can be configured so as to be integral with the mount 1040. For example, molded-in leaf springs may be formed during molding or machining of the mount 1040.

In one example embodiment, the force transmitting element or biasing element is attached to, integral with, or located on the articulating blade assembly and the force receiving structure is located in the mount. In one example embodiment, a flexible molded paddle extends to a slot in the mount when assembled.

The foregoing description of use of the device can be applied to the various implementations described herein through minor modifications, which can be apparent to the person of skill in the art in light of the further disclosure provided herein. The above description of use, however, is not intended to limit the use of the article but is provided to comply with all necessary requirements of disclosure of the present disclosure.

Many modifications and other implementations of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. An articulating blade assembly for a hair removal device, the articulating blade assembly comprising:
a blade housing comprising a blade retained therein;
a mount arranged to rotationally engage the blade housing so as to define an axis of rotation;
a biasing element having a first portion biased against the blade housing and a second portion biased against the mount such that pivoting of the blade housing about the axis of rotation causes the first portion biased against the blade housing to exert an opposing force upon the blade housing; and
a handle adapter engaged with the mount and aligned with a centrally-defined opening in the mount so as to engage a device body of the hair removal device.

2. The articulating blade assembly of claim 1, wherein the biasing element is formed integral with or attachable to the mount.

3. The articulating blade assembly of claim 1, wherein the mount is formed of a plastic, a metal, a wood, or a combination thereof.

4. The articulating blade assembly of claim 1, wherein the biasing element comprises a magnet, and wherein pivoting of the blade housing about the axis of rotation causes increases and decreases in magnetic field strength thereby creating opposing magnetic forces which bias the blade housing toward an initial position.

5. The articulating blade assembly of claim 1, wherein the blade housing is pivotable about the axis of rotation in either of two opposing directions from an initial position.

6. The articulating blade assembly of claim 1, wherein the blade housing extends longitudinally from a first end to an opposing second end and comprises a front surface and an opposing rear surface, the rear surface extending upward from each of the first end and the opposing second end to form drums having outer faces extending away from one another and force-receiving structures extending upward and parallel to one another.

7. The articulating blade assembly of claim 6, wherein the force-receiving structures each comprise a force-receiving surface, the force-receiving surfaces being substantially co-planar with one another.

8. The articulating blade assembly of claim 6, wherein the mount extends longitudinally from a first end to an opposing second end, each of the first end and the opposing second end defining a drum recess such that the drums of the first end and the opposing second end of the blade housing are arranged to engage respective drum recesses of the first end and the opposing second end of the mount and define the axis of rotation.

9. The articulating blade assembly of claim 8, wherein the first end and the opposing second end of the mount each further comprise a pin having an outer face, the outer faces of the pins extending toward one another.

10. The articulating blade assembly of claim 9, wherein the biasing element is a torsion spring having a coiled central portion arranged between the first portion and the second portion and arranged about a respective one of the pins, and wherein the first portion defines a moving end biased against the blade housing and the second portion defines a constrained end biased against the mount, such that pivoting of the blade housing about the axis of rotation causes the first portion to exert the opposing force against the blade housing.

11. The articulating blade assembly of claim 10, wherein the constrained end is biased against a top surface of the mount and the moving end is biased against the respective force-receiving structure of the blade housing, such that pivoting of the blade housing about the axis of rotation causes the moving ends of the torsion springs to exert an opposing force upon the respective force-receiving structures.

12. The articulating blade assembly of claim 10, further comprising two torsion springs and two pins, each of the torsion springs having the coiled central portion arranged about the respective one of the two pins.

13. A hair removal device comprising:
a blade assembly comprising:
a blade housing comprising a blade retained therein and extending longitudinally from a first end to an opposing second end and comprising a front surface and an opposing rear surface, the rear surface extending upward from each of the first end and the opposing second end to form drums having outer faces extending away from one another and force-receiving structures extending parallel to one another,
a mount extending longitudinally from a first end to an opposing second end, each of the first end and the opposing second end defining a drum recess such that the drums of the first end and the opposing second end of the blade housing are arranged to engage respective drum recesses of the first end and the opposing second end of the mount and define an axis of rotation, and the first end and the opposing second end of the mount each further comprising a pin having an outer face, the outer faces of the pins extending toward one another, and
a torsion spring having a coiled central portion arranged between a constrained end and a moving end of the torsion spring and arranged about a respective one of the pins, where the constrained end is biased against a top surface of the mount and the moving end is biased against the respective force-receiving structure of the blade housing, such that pivoting of the blade housing about the axis of rotation causes the moving ends of the torsion springs to exert an opposing force upon the respective force-receiving structures; and
a device body arranged to engage the blade assembly.

14. The hair removal device of claim 13, further comprising a handle adapter engaged with the mount and aligned with a centrally-defined opening in the mount so as to engage the device body of the hair removal device.

15. The hair removal device of claim 13, wherein the torsion spring is formed integral with or attachable to the mount.

16. The hair removal device of claim 13, wherein the blade housing is pivotable about the axis of rotation in either of two opposing directions from an initial position relative to the device body.

17. The hair removal device of claim 13, wherein the force-receiving structures each comprise a force-receiving surface, the force-receiving surfaces of each of the force-receiving structures being substantially co-planar with one another.

18. The hair removal device of claim 13, further comprising two torsion springs and two pins, each of the torsion springs having the coiled central portion arranged about the respective one of the two pins.

19. A method for manufacturing an articulating blade assembly, the method comprising:
providing a blade housing comprising a blade retained therein and extending longitudinally from a first end to an opposing second end and comprising a front surface and an opposing rear surface, the rear surface extending upward from each of the first end and the opposing second end to form drums having outer faces extending away from one another and force-receiving structures extending upward from each of the first end and the opposing second end and parallel to one another;
engaging a mount extending longitudinally from a first end to an opposing second end with the blade housing by engaging a drum recess defined in each of the first end and the opposing second end of the mount with the respective drums of the first end and the opposing second end of the blade housing so as to define an axis of rotation, the first end and the opposing second end of the mount each further comprising a pin having an outer face, the outer faces of the pins extending toward one another;
arranging a coiled central portion of a torsion spring about a respective one of the pins, the coiled central portion being arranged between a constrained end and a moving end of the torsion spring; and
biasing the constrained end of the torsion spring against a top surface of the mount and the moving end of the torsion spring against the respective force-receiving structure of the blade housing, such that pivoting of the blade housing about the axis of rotation causes the moving ends of the torsion springs to exert an opposing force upon the respective force-receiving structures.

20. The method of claim 19, further comprising engaging a device body with the articulating blade assembly to form a hair removal device.
